(19) United States
(12) Patent Application Publication
(10) Pub. No.: US 2020/0114881 A1
(43) Pub. Date: Apr. 16, 2020

(54) ONBOARD SENSOR CLEANING DEVICE

(71) Applicant: DENSO CORPORATION, Kariya-city, Aichi-pref. (JP)

(72) Inventors: Yuusuke YAMAUCHI, Kariya-city (JP); Masaaki KIYAMA, Kariya-city (JP); Yasuhiro HARITA, Kariya-city (JP)

(73) Assignee: DENSO CORPORATION, Kariya-city, Aichi-pref. (JP)

(21) Appl. No.: 16/619,124

(22) PCT Filed: Jun. 8, 2018
(86) PCT No.: PCT/JP2018/022054

§ 371 Date: Dec. 4, 2019

(30) Foreign Application Priority Data
Jul. 11, 2017 (JP) 2017-135420
Aug. 28, 2017 (JP) 2017-163557
Mar. 5, 2018 (JP) 2018-038881
Mar. 5, 2018 (JP) 2018-038882

(51) Int. Cl. B60S 1/60; F04B 53/10; F04B 49/22; B60S 1/52

(52) U.S. Cl. CPC B60S 1/60; B60S 1/52; F04B 49/22; F04B 53/10

(57) ABSTRACT

An onboard sensor cleaning device includes a nozzle opening, a pump, a flow passage, an on-off valve, and a pressure accumulator. The nozzle opening ejects fluid to a sensing surface of an onboard sensor. The pump sends fluid to the nozzle opening. The flow passage connects the nozzle opening and the pump. The on-off valve is arranged in the flow passage to open and close the flow passage based on a control signal. The pressure accumulator is arranged in the flow passage in a pump-side portion that is a portion between the on-off valve and the pump.

### CROSS-REFERENCE TO RELATED APPLICATIONS

This application is based upon Japanese Patent Application No. 2017-135420 filed on Jul. 11, 2017, Japanese Patent Application No. 2017-163557 filed on Aug. 28, 2017, Japanese Patent Application No. 2018-038881 filed on Mar. 5, 2018, and Japanese Patent Application No. 2018-038882 filed on Mar. 5, 2018, the entire contents of which are incorporated herein by reference.

### TECHNICAL FIELD

This disclosure relates to an onboard sensor cleaning device.

### BACKGROUND ART

Recent vehicles include an onboard sensor, such as a camera, and an onboard sensor cleaning device that ejects fluid from a nozzle opening to a sensing surface (lens, cover glass, or the like) of the onboard sensor to clean the sensing surface.

For example, Patent Document 1 discloses an onboard sensor cleaning device including a check valve arranged in a flow passage connecting a nozzle opening and a pump that sends fluid to the nozzle opening. In the onboard sensor cleaning device, the check valve prevents unintentional leakage of fluid out of the nozzle opening.

### PRIOR ART DOCUMENT

### Patent Document

Patent Document 1: Japanese Laid-Open Patent Application Publication No. 2013-208984

### SUMMARY OF INVENTION

In the conventional onboard sensor cleaning device, when the flow passage (piping) from the pump to the nozzle opening is particularly long, a pressure loss may occur in the flow passage. This may hinder the ejection of high-pressure fluid from the nozzle opening. More specifically, the pressure of the fluid may be drastically decreased in the vicinity of the nozzle opening from the pressure of the fluid in the vicinity of the pump. This will lower the speed of the fluid ejected from the nozzle opening. In the onboard sensor cleaning device including the check valve in the vicinity of the nozzle opening, the check valve does not open until the pressure becomes greater than or equal to a preset pressure. Thus, fluid is ejected in accordance with the preset pressure. However, in order to ensure that the check valve opens, the pressure at which the check valve opens cannot be set high. In other words, the pressure at which the check valve opens needs to be set sufficiently lower than pressure produced by the pump. Hence, the onboard sensor cleaning device may not be able to eject high-pressure fluid from the nozzle opening.

An object of this disclosure is to provide an onboard sensor cleaning device that ejects high-pressure fluid from a nozzle opening.

An onboard sensor cleaning device according to one embodiment of the present disclosure includes a nozzle opening, a pump, a flow passage, an on-off valve, and a pressure accumulator. The nozzle opening ejects fluid to a sensing surface of an onboard sensor. The pump sends fluid to the nozzle opening. The flow passage connects the nozzle opening and the pump. The on-off valve is arranged in the flow passage to open and close the flow passage based on a control signal. The pressure accumulator is arranged in the flow passage in a pump-side portion that is a portion between the on-off valve and the pump.

In this configuration, the onboard sensor cleaning device includes the on-off valve and the pressure accumulator. The on-off valve is arranged in the flow passage, which connects the nozzle opening with the pump that sends fluid to the nozzle opening, and opens and closes the flow passage based on a control signal. The pressure accumulator is arranged in the flow passage in the pump-side portion, which is a portion of between the on-off valve and the pump. The pump is driven when the on-off valve closes the flow passage to increase the pressure of the fluid in the pressure accumulator. The on-off valve opens the flow passage when the pressure of the fluid is high to send high-pressure fluid to the nozzle opening from the position of the on-off valve and eject high-pressure fluid from the nozzle opening to the sensing surface.

### BRIEF DESCRIPTION OF DRAWINGS

The disclosure, together with objects and advantages thereof, may best be understood by reference to the following description of the presently preferred embodiments together with the accompanying drawings in which:

FIG. 1 is a schematic diagram illustrating the configuration of an onboard sensor cleaning device according to a first embodiment;

FIG. 2 is a cross-sectional view of a pressure accumulator shown in FIG. 1;

FIG. 3 is an exploded perspective view of the pressure accumulator shown in FIG. 2;

FIG. 4 is a timing chart illustrating an actuation example of the onboard sensor cleaning device shown in FIG. 1;

FIG. 5 is a time-pressure characteristic diagram of a washer pump and the pressure accumulator shown in FIG. 1;

FIG. 6 is a schematic diagram illustrating an onboard sensor cleaning device according to a modified example;

FIG. 7 is a schematic diagram illustrating the configuration of the onboard sensor cleaning device according to the modified example;

FIG. 8 is a timing chart illustrating an actuation example of the onboard sensor cleaning device shown in FIG. 7;

FIG. 9 is a schematic diagram illustrating the configuration of an onboard sensor cleaning device according to a second embodiment;

FIG. 10 is a timing chart illustrating an actuation example of the onboard sensor cleaning device shown in FIG. 9;

FIG. 11A is a perspective view of an onboard camera and a cleaning unit shown in FIG. 9 at a non-cleaning position, and FIG. 11B is a perspective view of the onboard camera and the cleaning unit shown in FIG. 9 at a cleaning position;

FIG. 12 is an exploded perspective view of the onboard camera and the cleaning unit shown in FIG. 11A;

FIG. 13 is a cross-sectional view of a nozzle unit shown in FIG. 12;

FIG. 14 is a schematic diagram illustrating the configuration of an onboard sensor cleaning device according to another modified example;

FIG. 15 is a timing chart illustrating an actuation example of the onboard sensor cleaning device shown in FIG. 14;

FIG. 16 is a schematic diagram illustrating the configuration of an onboard sensor cleaning device according to a third embodiment;

FIG. 17 is a cross-sectional view of a flow passage switching device shown in FIG. 16;

FIG. 18 is an exploded perspective view of the flow passage switching device shown in FIG. 17;

FIGS. 19A and 19B are cross-sectional views illustrating the operation of the flow passage switching device shown in FIG. 18;

FIG. 20 is a time-pressure characteristic diagram in the third embodiment;

FIG. 21 is a timing chart illustrating an actuation example of the onboard sensor cleaning device shown in FIG. 16;

FIG. 22 is a cross-sectional view of a flow passage switching device according to a modified example;

FIG. 23 is an exploded perspective view showing part of the flow passage switching device according to a modified example;

FIG. 24 is a cross-sectional view of a flow passage switching device according to a modified example;

FIG. 25 is an exploded perspective view showing part of the flow passage switching device according to a modified example;

FIG. 26 is a cross-sectional view of a flow passage switching device according to a modified example;

FIG. 27 is an exploded perspective view of the flow passage switching device according to a modified example;

FIG. 28 is a schematic diagram illustrating the configuration of an onboard sensor cleaning device according to a fourth embodiment;

FIG. 29 is a timing chart illustrating an actuation example of the onboard sensor cleaning device in FIG. 28;

FIG. 30A is a perspective view of an onboard camera and a cleaning unit of FIG. 28 at a non-cleaning position, and FIG. 30B is a perspective view of the onboard camera and the cleaning unit of FIG. 28 at a cleaning position;

FIG. 31 is an exploded perspective view of the onboard camera and the cleaning unit shown in FIG. 30A;

FIG. 32 is a cross-sectional view of a nozzle unit shown in FIG. 31;

FIG. 33 is a schematic diagram illustrating the configuration of the onboard sensor cleaning device according to a modified example; and

FIG. 34 is a perspective view of a flow passage switching device according to the modified example.

### EMBODIMENTS OF THE INVENTION

### First Embodiment

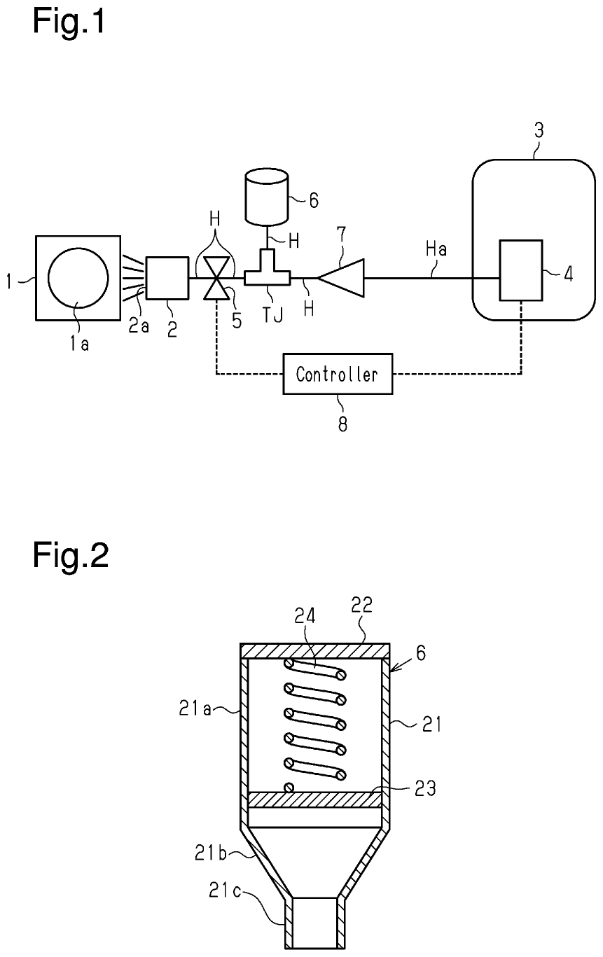

A first embodiment of an onboard sensor cleaning device will now be described with reference to FIGS. 1 and 2.

As illustrated in FIG. 1, a nozzle 2 is arranged in the vicinity of an onboard camera 1, which serves as an onboard sensor arranged on a vehicle. The nozzle 2 includes a nozzle opening 2a to eject a washer liquid, which serves as a fluid, toward a lens 1a, which serves as a sensing surface of the onboard camera 1.

In addition, a washer tank 3, which is arranged in the vehicle, includes a washer pump 4, which serves as a pump configured to send washer liquid from the washer tank 3 to the nozzle 2 (nozzle opening 2a).

In the present embodiment, an on-off valve 5 that opens and closes a flow passage based on a control signal is arranged in the flow passage, which connects the nozzle 2 (nozzle opening 2a) and the washer pump 4, in the vicinity of the nozzle 2. The on-off valve 5 is an electromagnetic valve configured to open and close the flow passage based on a control signal.

In addition, a pressure accumulator 6 is arranged in the flow passage, which connects the on-off valve 5 and the washer pump 4, in the vicinity of the on-off valve 5. That is, the pressure accumulator 6 is arranged in a pump-side portion of the flow passage connecting the nozzle opening 2a and the washer pump 4. The pump-side portion is a portion extending between the on-off valve 5 and the washer pump 4. The pressure accumulator 6 includes a chamber allowing for storage of at least the amount of washer liquid required to perform cleaning once.

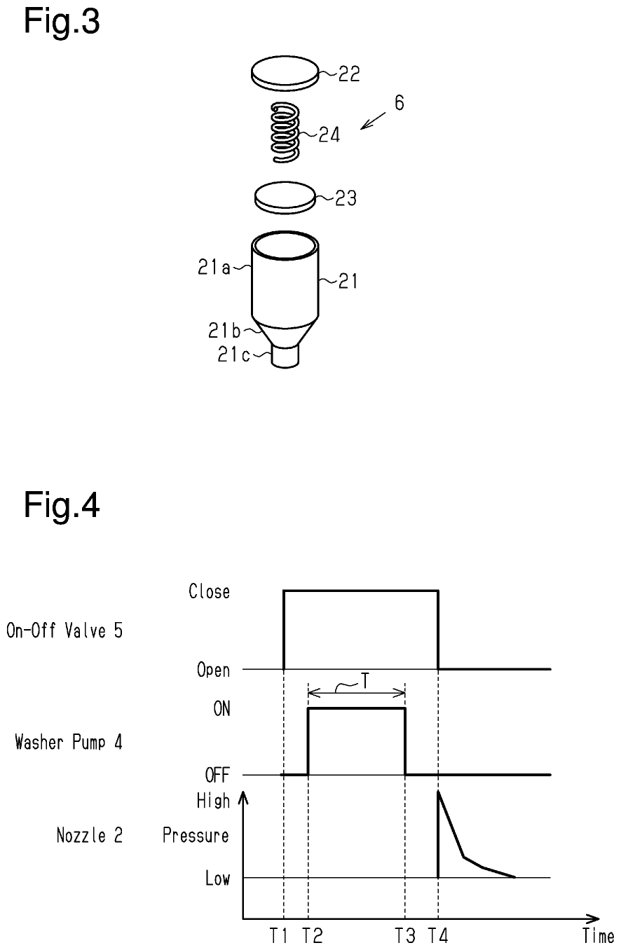

As illustrated in FIGS. 2 and 3, the pressure accumulator 6 includes a housing 21, a lid 22, a movable member 23, and a coil spring 24. The housing 21 includes a cylindrical portion 21a, which is cylindrical, a diameter decreasing portion 21b, which has a diameter that gradually decreases from a lower end of the cylindrical portion 21a toward a lower side, and a small-diameter cylindrical portion 21c, which is cylindrical and extends from a lower end of the diameter decreasing portion 21b. For example, the small-diameter cylindrical portion 21c is connected by a hose H to a T-shaped joint TJ, which will be described below.

The lid 22 is substantially disk-shaped and closes one end (upper end as viewed in FIG. 2) of the cylindrical portion 21a. The movable member 23 is substantially disk-shaped and movable along an axial direction of the cylindrical portion 21a so as to slide on an inner circumferential surface of the cylindrical portion 21a. Rubber seal (not illustrated) or the like is arranged on, for example, an outer circumferential surface of the movable member 23 to hermetically seal a chamber defined in the pressure accumulator 6. Accordingly, the coil spring 24 is located between the lid 22 and the movable member 23. The coil spring 24 biases the lid 22 toward the small-diameter cylindrical portion 21c.

Further, a check valve 7 is arranged in the flow passage that connects the pressure accumulator 6 and the washer pump 4 in the vicinity of the pressure accumulator 6 to restrict the flow (backflow) of washer liquid from the pressure accumulator 6 to the washer pump 4.

In the present embodiment, the nozzle 2, the on-off valve 5, the pressure accumulator 6, and the check valve 7 are configured independently from each other and connected to each other by a hose H that forms the flow passage. The pressure accumulator 6 is connected by the hose H and the T-shaped joint TJ to the hose H that is connected to the on-off valve 5 and the hose H that is connected to the check valve 7. In addition, the check valve 7 and the washer pump 4 are connected to each other by a hose Ha (first hose) having a smaller diameter (inner diameter) than that of the hose H (second hoses).

The hose H (second hose) connecting the nozzle 2, the on-off valve 5, the pressure accumulator 6, and the check valve 7 of the present embodiment have a higher hardness than the hose Ha (first hose) connecting the check valve 7 and the washer pump 4.

Accordingly, a controller 8 configured to drive and control the washer pump 4 and the on-off valve 5 is electrically connected to the washer pump 4 and the on-off valve 5. For example, when a cleaning switch near a driver seat is operated or when a sensor detects a smudge, the controller 8 drives the washer pump 4 in a state in which the on-off valve 5 is closing the flow passage. Then (when pressure in the pressure accumulator 6 is high), the controller 8 stops the washer pump 4, opens the flow passage with the on-off valve 5, and ejects washer liquid from the nozzle opening 2a.

A specific actuation example (operation) of the above-described onboard sensor cleaning device will now be described.

As illustrated in FIG. 4, for example, when the cleaning switch near the driver seat is operated or a sensor detects a smudge at time T1, the controller 8 closes the flow passage with the on-off valve 5. Then, the controller 8 drives the washer pump 4 at time T2. In this case, the controller 8 drives the washer pump 4 during a preset time T (between time T2 and time T3).

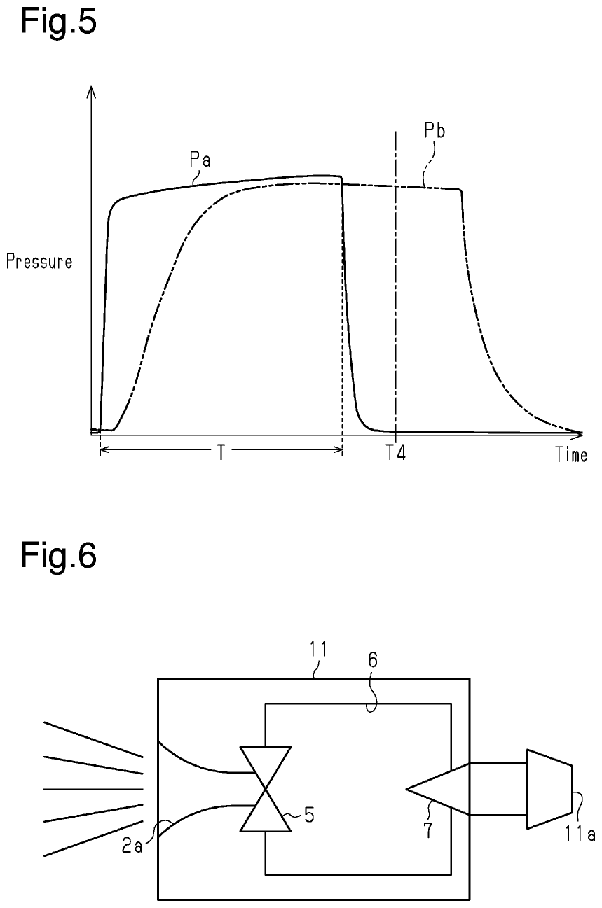

Consequently, as illustrated in FIG. 5, pressure Pa at an outlet of the washer pump 4 increases immediately after the washer pump 4 is driven, and the pressure Pa becomes high and remains substantially constant until the preset time T end (while washer pump 4 is driven). In this case, the pressure Pb of the pressure accumulator 6 (pressure of passage from on-off valve 5 to check valve 7) is high and substantially the same as the pressure Pa at the outlet of the washer pump 4.

The controller 8 stops the washer pump 4 at time T3 and then opens the flow passage with the on-off valve 5 at time T4. In the state of time T4, the pressure Pa at the outlet of the washer pump 4 is decreased but the pressure Pb of the pressure accumulator 6 (pressure of passage from on-off valve 5 to check valve 7) is kept high. Consequently, high-pressure washer liquid is ejected from the nozzle opening 2a to clean the lens 1a of the onboard camera 1. When the washer liquid is ejected, the pressure Pb of the pressure accumulator 6 decreases. FIG. 5 illustrates waveforms obtained from experiment results. The pressure Pa is a value obtained by connecting a pressure gauge to the outlet of the washer pump 4, and the pressure Pb is a value obtained by connecting a pressure gauge between the on-off valve 5 and the T-shaped joint TJ.

The advantages of the first embodiment will now be described.

(1) The on-off valve 5 is arranged in the flow passage that connects the nozzle opening 2a and the washer pump 4 and opens and closes the flow passage based on a control signal. The pressure accumulator 6 is arranged in the flow passage that connects the on-off valve 5 and the washer pump 4. In other words, the pressure accumulator 6 is arranged in the flow passage including the on-off valve 5 in the portion between the on-off valve 5 and the washer pump 4. Therefore, pressure of the washer liquid in the pressure accumulator 6 can be increased by closing the flow passage with the on-off valve 5 and driving the washer pump 4. The on-off valve 5 opens the flow passage in a state in which the pressure of the washer liquid is high to send the high-pressure washer liquid to the nozzle opening 2a from the position of the on-off valve 5 to eject the high-pressure washer liquid from the nozzle opening 2a to the lens 1a. Thus, a high cleaning force is obtained with a small amount of washer liquid. In addition, with this configuration, there is no need to consider pressure loss of the flow passage connecting the on-off valve 5 (or check valve 7) and the washer pump 4 in contrast with a configuration that does not include, for example, the on-off valve 5. Therefore, the flow passage can be formed by small-diameter piping (hose) or the like. This reduces the cost of parts and facilitates the layout or the like. Specifically, in the present embodiment, the hose Ha that is long and laid out in the vehicle connecting the check valve 7 and the washer pump 4 can be smaller in diameter than the hoses H that connects the nozzle 2, the on-off valve 5, the pressure accumulator 6, and the check valve 7. This facilitates the layout and reduces costs. In addition, the hoses H that connect the nozzle 2, the on-off valve 5, the pressure accumulator 6, and the check valve 7 in the present embodiment have a hardness set to be higher than that of the hose Ha that connects the check valve 7 and the washer pump 4. The flexibility of the hoses H reduces pressure loss between the check valve 7 and the nozzle opening 2a. Further, in this configuration, the hose Ha has relatively low hardness and facilitates layout.

(2) The check valve 7 is arranged in the flow passage that connects the pressure accumulator 6 and the washer pump 4. In other words, the check valve 7 is arranged in the flow passage including the on-off valve 5 in the portion between the pressure accumulator 6 and the washer pump 4. The check valve 7 restricts the flow of washer liquid from the pressure accumulator 6 to the washer pump 4. Therefore, the washer liquid in the pressure accumulator 6 does not flow back to the washer pump 4, and the pressure of the washer liquid does not decrease. Consequently, when the flow passage is closed by the on-off valve 5 and the washer pump 4 is driven, the pressure of the washer liquid increases in the pressure accumulator 6. After the washer pump 4 is stopped, the on-off valve 5 opens the flow passage to eject only high-pressure fluid from the nozzle opening 2a. In the present embodiment, the controller 8 performs this operation. In a configuration that does not include the check valve 7, when washer liquid is ejected from the nozzle opening 2a, there is a need to, for example, open the flow passage with the on-off valve 5 while driving the washer pump 4 so that the washer liquid in the pressure accumulator 6 will not flow back toward the washer pump 4. In this case, the washer pump 4 will increase electric-power consumption, and the washer liquid will not be ejected by accumulated pressure. The present embodiment avoids such a situation.

### Second Embodiment

A second embodiment of the onboard sensor cleaning device will now be described. The description hereafter will focus on differences of the present embodiment from the first embodiment. Same reference numerals are given to those components that are the same as the corresponding components of the first embodiment.

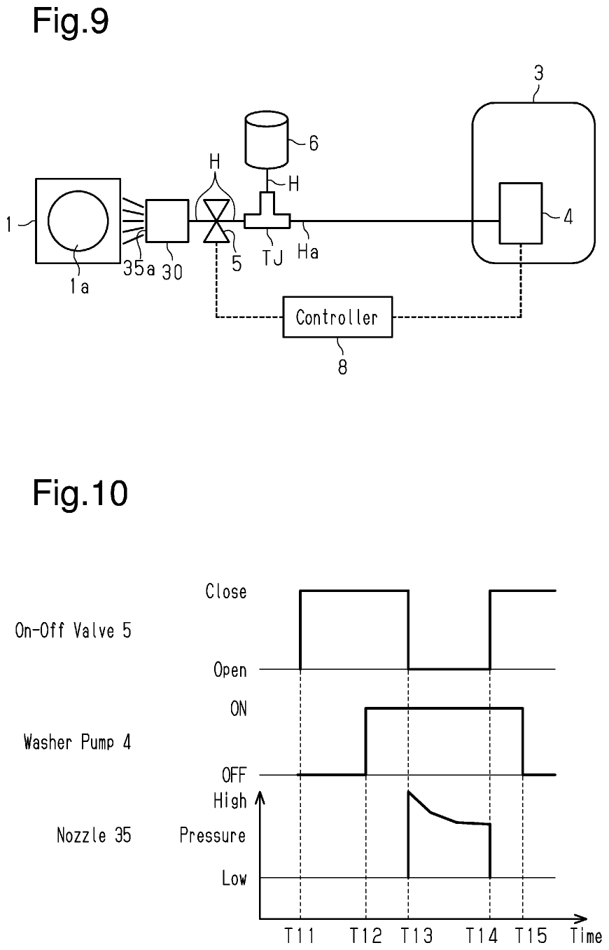

As illustrated in FIGS. 9, 11, and 12, the onboard sensor cleaning device of the embodiment includes a cleaning unit 30 that is integrated with the onboard camera 1.

The cleaning unit 30 includes a coupling fixing member 31 that is fixed to the onboard camera 1 and a nozzle unit 32 that is fixed to the coupling fixing member 31. The coupling fixing member 31 has a holder 31a that is substantially box-shaped and allows the onboard camera 1 to be fitted therein. The onboard camera 1 is fitted into the holder 31a to fix the coupling fixing member 31 to the onboard camera 1. FIG. 9 illustrates a state in which the onboard camera 1 is separated from the cleaning unit 30.

In addition, the coupling fixing member 31 includes two holding pieces 31b. The two holding pieces 31b include opposing surfaces with a groove formed in each surface. The nozzle unit 32 is coupled in a removable manner to the holding pieces 31b.

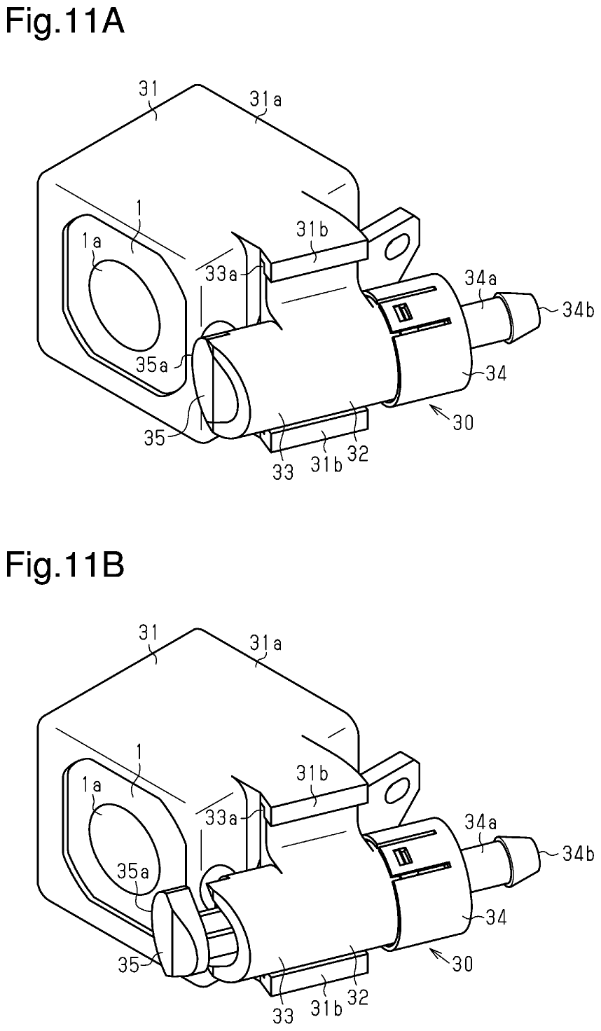

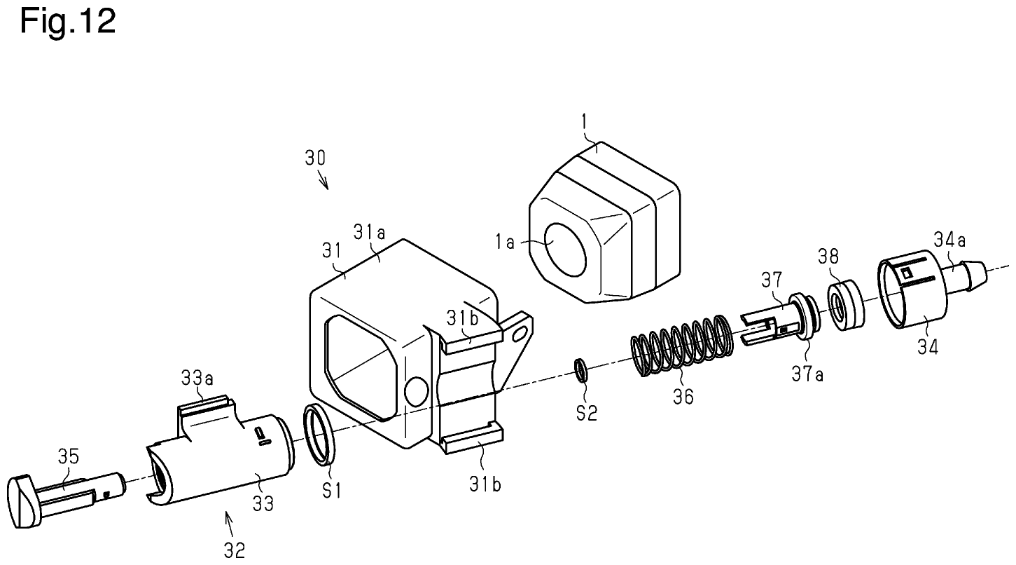

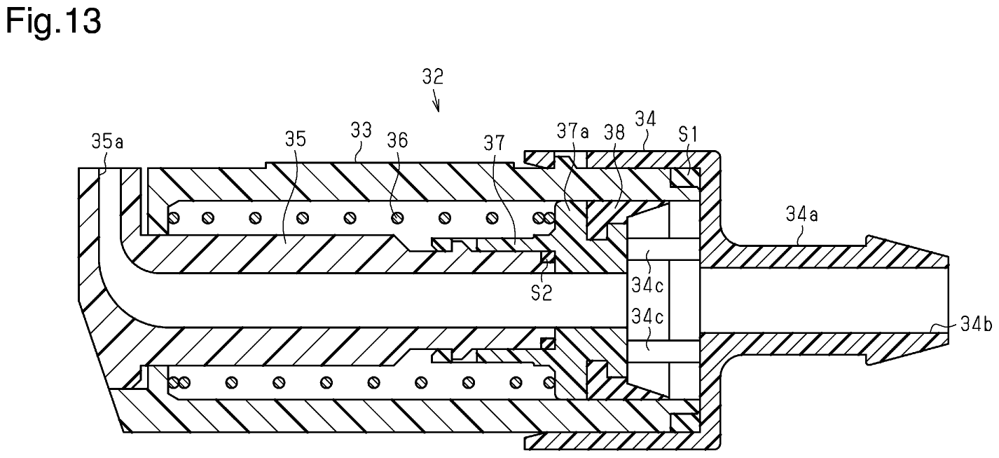

The nozzle unit 32 includes a first case 33 that is substantially cylindrical and a second case 34 that is fitted onto and fixed to a proximal side of the first case 33. Two fixing projections 33a (only one shown in FIGS. 11A, 11B, and 12) are formed on the outer circumference of the first case 33 and fitted into the grooves of the holding pieces 31b so that the nozzle unit 32 is coupled in a removable manner to the holding pieces 31b (coupling fixing member 31). A cylindrical inlet tube 34a projects from a bottom portion of the second case 34. The inner side of the inlet tube 34a defines an inlet port 34b (refer to FIG. 13) connected to the inside of the first case 33. A seal ring S1 is located between the first case 33 and the second case 34.

In addition, as illustrated in FIGS. 12 and 13, the nozzle unit 32 includes a movable nozzle 35 and a compression coil spring 36. The movable nozzle 35 is movable forward and backward to be projected out of and retracted into an opening in the distal end of the first case 33. The compression coil spring 36 serves as a biasing member that biases the movable nozzle 35 in a backward direction (proximal end direction of first case 33).

More specifically, as illustrated in FIG. 13, the movable nozzle 35 is cylindrical and has a smaller diameter than the first case 33. The movable nozzle 35 has a distal end directed sideward (direction orthogonal to longitudinal direction) to form a nozzle opening 35a. A proximal end member 37 is fitted onto a proximal portion of the movable nozzle 35. A seal ring S2 is located between the movable nozzle 35 and the proximal end member 37. The proximal end member 37 has a flange 37a that extends radially outward, and the flange 37a is biased by the compression coil spring 36. One end of the compression coil spring 36 is supported by the distal end of the first case 33. This biases the movable nozzle 35 in the retracting direction (right direction as viewed in FIG. 13). In addition, an annular seal member 38 that slides in contact with an inner circumferential surface of the first case 33 is fitted to a proximal portion of the proximal end member 37.

Further, the bottom portion of the second case 34 includes a restriction post 34c that extends toward a side opposite to the inlet tube 34a. In this example, three restriction posts 34c (only two shown in FIG. 13) are formed at equal angular intervals in the circumferential direction. The restriction posts 34c contact a proximal end surface of the proximal end member 37 biased by the compression coil spring 36 to restrict further retraction of the proximal end member 37 (movable nozzle 35) beyond the position of contact.

As illustrated in FIG. 9, the washer pump 4 is connected to the inlet tube 34a (inlet port 34b) to supply washer liquid to the cleaning unit 30 (nozzle unit 32). The on-off valve 5 and the T-shaped joint TJ are arranged near the cleaning unit 30 in the flow passage between the cleaning unit 30 and the washer pump 4. The cleaning unit (inlet tube 34a), the on-off valve 5, and the pressure accumulator 6 are configured independently and connected to one another by the hoses H and Ha of the flow passage. The pressure accumulator 6 is connected by the hose H and the T-shaped joint TJ to the hose H connected to the on-off valve 5 and the hose Ha connected to the washer pump 4. That is, this example employs a configuration in which the check valve 7 of the first embodiment is omitted from the configuration of the present example. The hose Ha forming the flow passage between the washer pump 4 and the pressure accumulator 6 has a smaller inner diameter than the other hoses H and is thus thin. In addition, the hose Ha has a lower hardness than the hoses H.

When washer liquid is supplied from the inlet port 34b to the inside of the movable nozzle 35, the proximal end surface of the proximal end member 37 is biased by the pressure of the washer liquid. This moves the movable nozzle 35 forward against the biasing force of the compression coil spring 36.

In the onboard sensor cleaning device, the movable nozzle 35 is moved forward and backward so that the nozzle opening 35a of the movable nozzle 35 is movable to a cleaning position, which is close to an image capturing range (center of image capturing range) of the onboard camera 1 and a non-cleaning position, which is farther from the image capturing range than the cleaning position. The image capturing range of the present embodiment is a range in which the onboard camera 1 (imaging element thereof) captures images through the lens 1a.

More specifically, in the present embodiment, the non-cleaning position is set at a position where the nozzle opening 35a is located outside the image capturing range of the onboard camera 1, and the cleaning position is set at a position where the nozzle opening 35a is located inside the image capturing range of the onboard camera 1. Thus, in a backward state in which the movable nozzle 35 is moved backward (state in which proximal end surface of proximal end member 37 is in contact with restriction posts 34c), the nozzle opening 35a is located outside the image capturing range of the onboard camera 1 at the non-cleaning position. In a forward state in which the movable nozzle 35 is moved forward, the nozzle opening 35a is located inside the image capturing range of the onboard camera 1 at the cleaning position.

In the present embodiment, the direction in which the movable nozzle 35 is movable forward and backward is inclined relative to a direction extending toward the lens 1a of the onboard camera 1 (central axis of lens 1a, or image capturing axis). That is, when the movable nozzle 35 is moved forward in the forward state, the nozzle opening 35a is close to the image capturing axis (central axis line of lens 1a) and arranged at a position close to the center of the image capturing range of the onboard camera 1, and the nozzle opening 35a is inclined so that the washer liquid is ejected from the nozzle opening 35a to a center position of the lens 1a.

In the present embodiment, the movable nozzle 35 is located sideward in the horizontal direction from the onboard camera 1 so that the nozzle opening 35a is located sideward in the horizontal direction from the lens 1a at the non-cleaning position.

An actuation example (operation) of the onboard optical sensor cleaning device of the present embodiment will now be described.

First, in a state in which the washer pump 4 is not driven, the movable nozzle 35 is in a state moved backward to the non-cleaning position by the biasing force of the compression coil spring 36 (refer to FIG. 11A). Thus, the nozzle opening 35a (distal portion of movable nozzle 35) is located outside the image capturing range of the onboard camera 1. Hence, when cleaning is not performed and an image is captured, the nozzle opening 35a (distal portion of movable nozzle 35) does not interfere with image capturing.

As illustrated in FIG. 10, when, for example, a cleaning switch near the driver seat is operated or a sensor detects a smudge at time T11, the controller 8 closes the flow passage with the on-off valve 5. Then, the controller 8 drives the washer pump 4 at time T12. Consequently, the pressure at the outlet of the washer pump 4 increases immediately after the washer pump 4 is driven, and the pressure becomes high and remains substantially constant. In this case, the pressure of the pressure accumulator 6 also becomes high.

Then, the controller 8 drives the on-off valve 5 to open the flow passage at time T13. Consequently, high-pressure washer liquid is ejected from the movable nozzle 35 (nozzle opening 35a). This removes foreign matter or the like from the lens 1a to perform cleaning.

Then, the controller 8, for example, drives the on-off valve 5 to close the flow passage at time T14 and stop the ejection of washer liquid from the movable nozzle 35 (nozzle opening 35a).

Subsequently, the controller 8 stops the washer pump 4 at time T15. In this manner, the washer pump 4 is driven until the ejection of the washer liquid from the movable nozzle 35 is stopped so that the washer liquid is ejected at a high pressure from the movable nozzle 35.

In addition to advantage (1) of the first embodiment, the onboard sensor cleaning device has the advantages described below.

(3) The movable nozzle 35 includes the nozzle opening 35a, and the nozzle opening 35a is movable to the cleaning position, which is close to the center of the image capturing range of the onboard camera 1, and the non-cleaning position, which is farther from the center of the image capturing range than the cleaning position. Thus, the nozzle opening 35a is movable to the cleaning position only when performing cleaning. Thus, the lens 1a is smoothly cleaned without interfering image capturing.

(4) The movable nozzle 35 including the nozzle opening 35a is movable forward and backward to the cleaning position and the non-cleaning position. This reduces the region required for movement as compared with, for example, when relatively moving an external imaging surface (lens 1a) and the nozzle opening 35a.

(5) The onboard camera 1 including the lens 1a is fixed to the vehicle and thus, for example, captures stable images. Further, the nozzle opening 35a is arranged in the movable nozzle 35 that is supported by the vehicle in a manner movable forward and backward. Thus, forward and backward movement is performed more easily than when fixing the nozzle opening 35a and moving the onboard camera 1 forward and backward instead. That is, when, for example, the external imaging surface (lens 1a) is movable forward and backward, a mechanism including the onboard camera 1 will be enlarged. Compared to such a mechanism, the movable nozzle 35 is smaller and lighter in a configuration in which the external imaging surface is provided directly or indirectly on the vehicle (onboard camera 1). Therefore, the configuration that moves the movable nozzle 35 forward and backward allows for easy switching between forward and backward movement.

(6) The nozzle opening 35a is movable forward to approach the lens 1a of the onboard camera 1. This allows the movable nozzle 35 to easily eject washer liquid from, for example, a forward position located close to the image capturing axis (center axis of lens 1a) to the center position of the lens 1a. Thus, the lens 1a can be cleaned in a further satisfactory manner.

(7) The movable nozzle 35 is moved forward to the cleaning position by the pressure of the washer liquid (fluid). Thus, there is no need to provide an electric drive unit or the like that moves the movable nozzle 35 forward. This allows the configuration to be simplified.

(8) The movable nozzle 35 is moved backward to the non-cleaning position by the biasing force of the compression coil spring 36 (biasing member). Thus, there is no need for an electric drive unit or the like that moves the movable nozzle 35 backward. This allows the configuration to be simplified.

(9) The nozzle unit 32, which includes the movable nozzle 35 that is movable forward and backward, is coupled in a removable manner to the vehicle. Thus, the nozzle unit 32 is easy to remove and replace with a new nozzle unit when, for example, the movable nozzle 35 fails to move forward or backward.

(10) The nozzle opening 35a is rectangular when viewed from an opening direction. This allows washer liquid to be ejected over a wide region while maintaining high ejection pressure. Thus, the lens 1a can be cleaned in a further satisfactory manner.

(11) The fluid is a mixture of the washer liquid (liquid) and air. Thus, the lens 1a can be cleaned in a further satisfactory manner by increasing the ejection pressure (increasing flow speed) compared to when the fluid includes only the washer liquid (liquid), for example. Further, the consumption amount of the washer liquid can be reduced.

(12) The nozzle opening 35a is only arranged sideward in the horizontal direction from the lens 1a at the non-cleaning position. Thus, even when, for example, liquid falls from the nozzle opening 35a at the non-cleaning position after cleaning, the liquid will not collect on the lens 1a.

(13) The non-cleaning position is where the nozzle opening 35a is located outside the image capturing range of the onboard camera 1, and the cleaning position is where the nozzle opening 35a is located inside the image capturing range of the onboard camera 1. The nozzle opening 35a is movable to the cleaning position only during cleaning. Thus, the lens 1a can be cleaned in a further satisfactory manner without interfering with the capturing of images.

The first and second embodiments may be modified as described below.

In the first embodiment, the nozzle 2 (nozzle opening 2a), the on-off valve 5, the pressure accumulator 6, and the check valve 7 are independently configured (connected by hoses H). Instead, the nozzle opening 2a, the on-off valve 5, the pressure accumulator 6, and the check valve 7 may be, for example, arranged in the same housing.

Specifically, as schematically illustrated in FIG. 6, a housing 11 includes the pressure accumulator 6 (chamber) in addition to the nozzle opening 2a and an inlet port 11a which are connected to the pressure accumulator 6. In the housing 11, the on-off valve 5 is located between the pressure accumulator 6 and the nozzle opening 2a, and the check valve 7 is located between the pressure accumulator 6 and the inlet port 11a. The washer pump 4 is connected to the inlet port 11a by a pipe (hose Ha or the like).

In this case, the nozzle opening 2a, the on-off valve 5, the pressure accumulator 6, and the check valve 7 are arranged in the same housing 11. Thus, there is no need to use the hoses H or the like for connection. Obviously, any configuration may be employed, in which the nozzle 2 (nozzle opening 2a) is separate, and the on-off valve 5, the pressure accumulator 6, and the check valve 7 are arranged in the same housing, or the like.

In the first and second embodiments, the present invention is applied to the onboard sensor cleaning device that ejects only washer liquid. Instead, the present invention may be applied to an onboard sensor cleaning device that ejects air.

For example, the washer pump 4 may be changed to an air pump that delivers air.

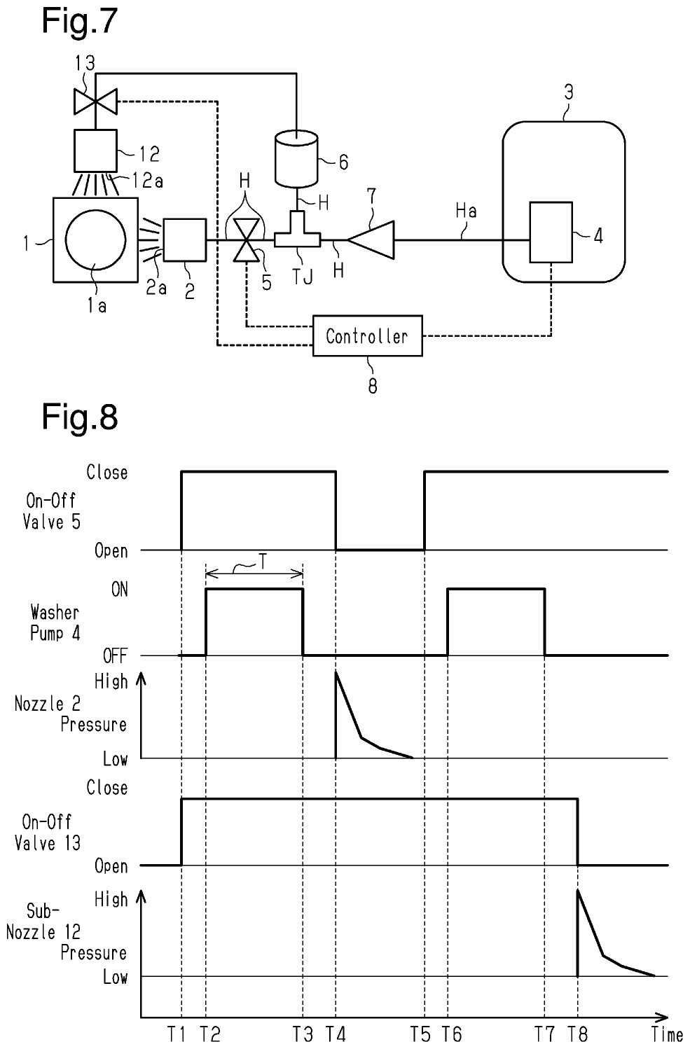

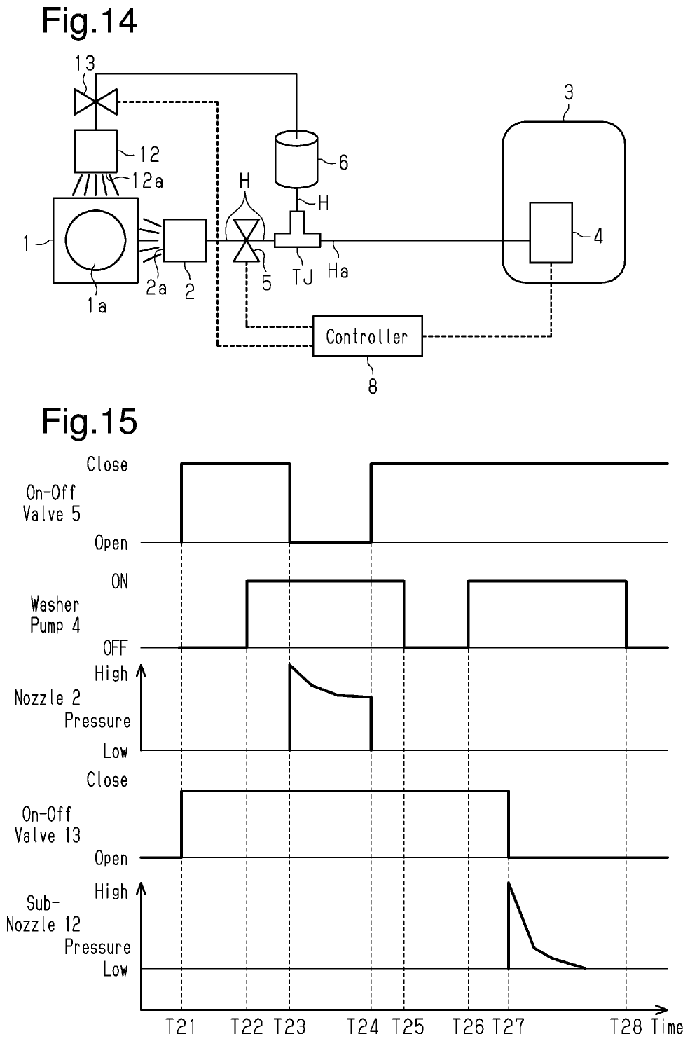

Further, the onboard sensor cleaning device may be modified to, for example, the configuration illustrated in FIG. 7 or the configuration illustrated in FIG. 14. As illustrated in FIG. 7, the pressure accumulator 6 is configured to store air (together with washer liquid) that is compressed by the washer liquid sent from the washer pump 4. Further, the onboard sensor cleaning device may include a sub-nozzle opening 12a (sub-nozzle 12) that ejects air to the lens 1a and a sub-on-off valve 13 that is arranged in a flow passage connecting the sub-nozzle opening 12a and the pressure accumulator 6 (upper portion thereof). The sub-on-off valve 13 opens and closes the flow passage based on a control signal.

This allows high-pressure washer liquid to be ejected from the nozzle opening 2a and high-pressure air to be ejected from the sub-nozzle opening 12a. Specifically, for example, when the on-off valve 5 and the sub-on-off valve 13 close the corresponding flow passages, the washer pump 4 is driven to increase the pressure of the washer liquid and the air in the pressure accumulator 6. The sub-on-off valve 13, for example, opens the corresponding flow passage to eject high-pressure air from the sub-nozzle opening 12a to the lens 1a.

FIG. 8 illustrates a timing chart of a control example of the onboard sensor cleaning device having the configuration illustrated in FIG. 7.

As illustrated in FIG. 8, for example, when a cleaning switch near the driver seat is operated or a sensor detects a smudge at time T1, the controller 8 closes the flow passages with the on-off valve 5 and the on-off valve 13. Then, the controller 8 drives the washer pump 4 at time T2. In this case, the controller 8 drives the washer pump 4 only for a preset time T (between time T2 and time T3).

The controller 8 stops the washer pump 4 at time T3 and then drives the on-off valve 5 at time T4 to open the corresponding the flow passage. In the state of time T4, the pressure Pa at the outlet of the washer pump 4 decreases but the pressure Pb of the pressure accumulator 6 (pressure of passage from on-off valve 5 to check valve 7) is kept high. Thus, high-pressure washer liquid is ejected from the nozzle opening 2a, and the lens 1a of the onboard camera 1 is cleaned. When the washer liquid is ejected, the pressure Pb of the pressure accumulator 6 decreases.

After the ejection of washer liquid from the nozzle 2 ends, the controller 8 closes the flow passage with the on-off valve 5 at time T5.

Then, the controller 8 drives the washer pump 4 at time T6. In this case, the controller 8 drives the washer pump 4 only for a preset time T (between time T6 and time T7).

The controller 8 stops the washer pump 4 at time T7 and then drives the on-off valve 13 to open the corresponding flow passage at time T8. In the state of time T8, the pressure Pa at the outlet of the washer pump 4 decreases but the pressure Pb of the pressure accumulator 6 is kept high. Thus, high-pressure air is ejected from the sub-nozzle opening 12a, and the lens 1a of the onboard camera 1 is cleaned.

The configuration illustrated in FIG. 14 is a configuration in which the check valve 7 is omitted from the configuration illustrated in FIG. 7. This configuration also allows the ejection of high-pressure washer liquid from the nozzle opening 2a and the ejection of high-pressure air from the sub-nozzle opening 12a. Specifically, when the on-off valve 5 and the sub-on-off valve 13 close the corresponding flow passages and the washer pump 4 is driven, the pressure of the washer liquid and the air is increased in the pressure accumulator 6. When, for example, the sub-on-off valve 13 opens the flow passage, high-pressure air is ejected from the sub-nozzle opening 12a to the lens 1a. Such a configuration may employ the cleaning unit 30 of the second embodiment.

FIG. 15 illustrates a timing chart of a control example of the onboard sensor cleaning device having the configuration illustrated in FIG. 14.

As illustrated in FIG. 15, when a cleaning switch near the driver seat is operated or a sensor detects a smudge at time T21, the controller 8 closes the flow passages with the on-off valve 5 and the on-off valve 13. Then, the controller 8 drives the washer pump 4 at time T22. Consequently, the pressure at the outlet of the washer pump 4 increases immediately after the washer pump 4 is driven, and the pressure becomes high and remains substantially constant. In this case, the pressure in the pressure accumulator 6 also becomes high.

Then, the controller 8 drives the on-off valve 5 to open the corresponding flow passage at time T23 and eject high-pressure washer liquid from the nozzle 2 (nozzle opening 2a). This removes foreign matter or the like from the lens 1a and performs cleaning.

Then, the controller 8 drives the on-off valve 5 to close the flow passage at, for example, time T24 and stop the ejection of washer liquid from the nozzle 2 (nozzle opening 2a).

Then, the controller 8 stops the washer pump 4 at time T25. In this manner, the washer pump 4 is driven until the ejection of the washer liquid from the movable nozzle 35 is stopped. Thus, the pressure of the washer liquid ejected from the movable nozzle 35 is high.

Then, the controller 8 drives the washer pump 4 at time T26. Consequently, the pressure in the outlet of the washer pump 4 increases immediately after the washer pump 4 is driven, and the pressure becomes high and remains substantially constant. In this case, the pressure in the pressure accumulator 6 also becomes high.

Subsequently, the controller 8 drives the on-off valve 13 to open the flow passage at time T27 and eject high-pressure air from the sub-nozzle opening 12a. This cleans the lens 1a of the onboard camera 1.

In the first and second embodiments, the pressure accumulator 6 is an independent chamber. Instead, the flow passage (e.g., hose) may function as the pressure accumulator. Specifically, the pressure accumulator 6 and the T-shaped joint TJ of the embodiments may be omitted, and, for example, the hoses H that connect the nozzle 2, the on-off valve 5, and the check valve 7 may function as the pressure accumulator. In this case, the hoses H that connect the nozzle 2, the on-off valve 5, and the check valve 7 are larger in diameter than the hose Ha that connects the check valve 7 and the washer pump 4. Thus, the hose Ha that is long and laid out in the vehicle is inexpensive and easy to lay out. The hose Ha also obtains the required volume for the pressure accumulator.

In the first embodiment, the controller 8 drives the washer pump 4 only for the preset time T (refer to FIG. 5). Instead, the controller 8 may be configured to stop the washer pump 4 based on, for example, the pressure of the pressure accumulator 6 after the washer pump 4 is driven. Obviously, the washer pump may be stopped based on time or pressure also at time T4 at which the controller 8 drives the on-off valve 5 to open the flow passage.

The first and second embodiments are configured and controlled so that after the washer liquid is ejected once, the pressure Pb of the pressure accumulator 6 decreases to substantially zero (washer pump 4 needs to be driven again to perform ejection for second time). Instead, a configuration and control may be employed so that when the pressure of the washer liquid in the pressure accumulator 6 is increased once, the washer liquid is ejected a multiple number of times.

In the first and second embodiments, the washer liquid is ejected to clean the lens 1a of the onboard camera 1. However, fluid may be ejected to clean a sensing surface (lens, cover glass, or the like) of an onboard sensor used in a device other than the onboard camera 1. For example, the onboard sensor may be an optical sensor (i.e., Lidar) that emits (radiates) infrared laser and receives scattered light reflected from an object to measure the distance to the object. In addition, radar (e.g., millimeter wave radar) that uses radio waves or an ultrasonic sensor used as a corner sensor may be employed.

The first embodiment, the second embodiment, and the modified examples may be combined with one another.

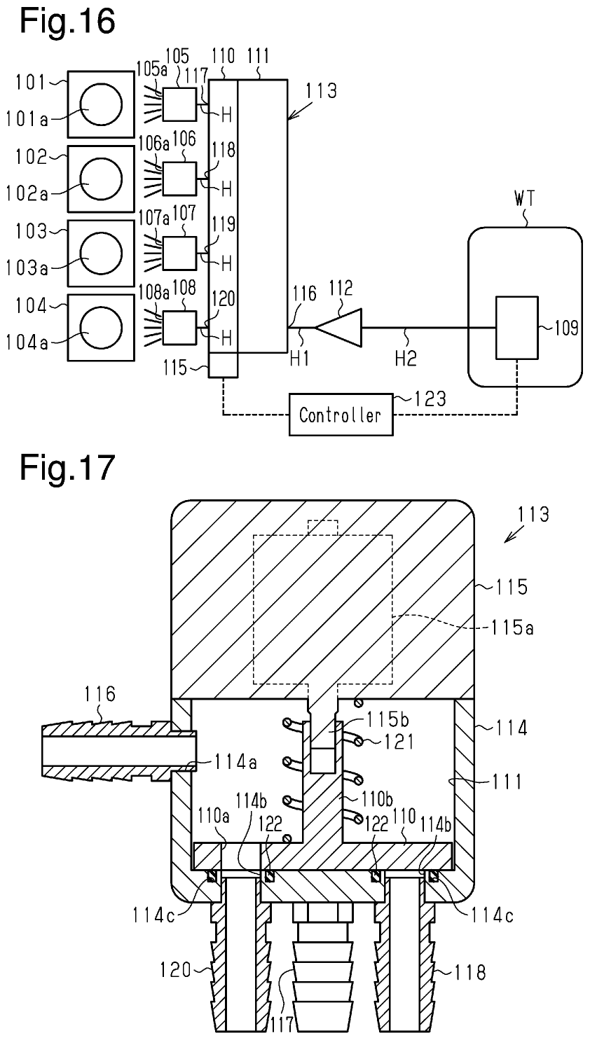

Hereinafter, a third embodiment of the onboard sensor cleaning device will now be described with reference to FIGS. 16 to 21.

As illustrated in FIG. 16, a plurality of (four in the present embodiment) onboard cameras 101 to 104 serving as onboard sensors are arranged in a vehicle. The cameras 101 to 104 respectively include lenses 101a to 104a serving as sensing surfaces of the onboard cameras 101 to 104. First to fourth nozzles 105 to 108 including nozzle openings 105a to 108a are arranged in the vicinity of the onboard cameras 101 to 104 (each onboard camera 101) to eject washer liquid, which serves as a fluid, to the lenses 101a to 104a, respectively. The onboard cameras 101 to 104 of the present embodiment include, for example, the onboard camera 101 arranged on a driver door, the onboard camera 102 arranged on a passenger door, two onboard cameras 103 and 104 arranged on a windshield, or the like. The onboard cameras 101 to 104 are located relatively close to each other.

In addition, a washer tank WT arranged in the vehicle includes a washer pump 109, which serves as a pump configured to send washer liquid from the washer tank WT to the first to fourth nozzles 105 to 108 (nozzle openings 105a to 108a).

In the present embodiment, a communication valve 110 is arranged in the flow passage connecting the first to fourth nozzles 105 to 108 (nozzle openings 105a to 108a) and the washer pump 109 in the vicinity of the first to fourth nozzles 105 to 108. Based on a control signal, the communication valve 110 allows the flow passage at the side of the washer pump 109 to be connected to one of the nozzle openings 105a to 108a and the flow passage at the side of the washer pump 109 to be disconnected from all of the nozzle openings 105a to 108a.

In addition, a pressure accumulator 111 is arranged in the flow passage connecting the communication valve 110 and the washer pump 109. That is, the pressure accumulator 111 is arranged in at a pump-side portion of the flow passage that connects the nozzle openings 105a to 108a and the washer pump 109. The pump-side portion is located between a rotary plate (communication valve 110) and the washer pump 109. The pressure accumulator 111 includes a chamber configured to store at least the amount of washer liquid required to perform cleaning once.

In addition, a check valve 112 that restricts the flow (backflow) of washer liquid from the pressure accumulator 111 to the washer pump 109 is arranged in the flow passage connecting the pressure accumulator 111 and the washer pump 109 in the vicinity of the pressure accumulator 111. That is, the check valve 112 is arranged in the flow passage connecting the pressure accumulator 111 and the washer pump 109 at a portion between the pressure accumulator 111 and the washer pump 109.

In the present embodiment, the communication valve 110 and the pressure accumulator 111 are integrated to form a flow passage switching device 113.

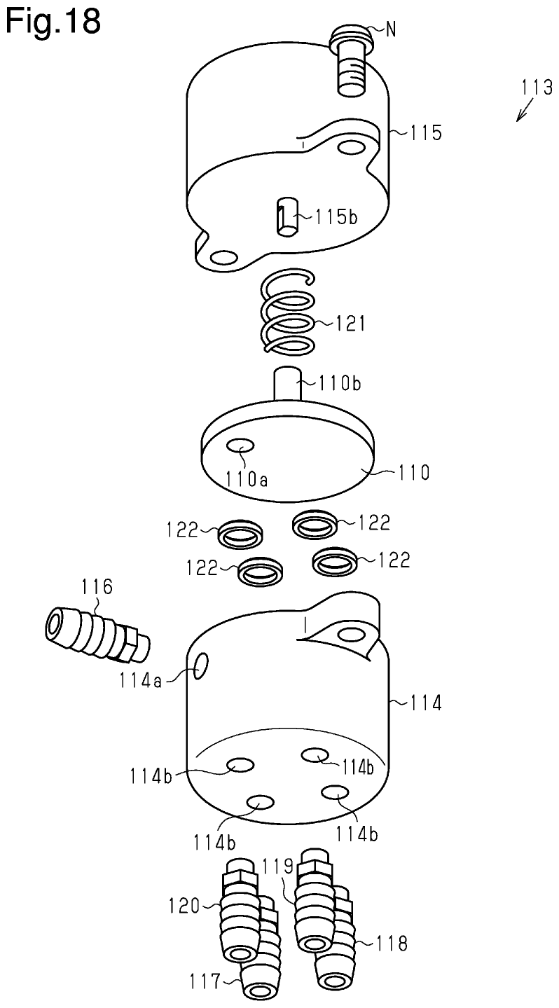

In detail, as illustrated in FIGS. 17 and 18, the flow passage switching device 113 includes the communication valve 110, which serves as the rotary plate, a case 114, which is substantially cylindrical and has a closed bottom to configure the pressure accumulator 111, a stepping motor 115, which serves as a drive source, a single inlet member 116, first to fourth outlet members 117 to 120, a compression coil spring 121, and four annular rubber seals 122.

A circumferential wall through hole 114a is formed in part of a circumferential wall of the case 114. The inlet member 116, which is substantially cylindrical, is fixed to the circumferential wall through hole 114a projecting outward. Four bottom through holes 114b are formed at equal angular intervals (90°) in the bottom portion of the case 114. The first to fourth outlet members 117 to 120, which are substantially cylindrical, are fixed to the bottom through holes 114b projecting outward. An accommodation groove 114c is formed in the bottom surface of the case 114 around each bottom through hole 114b. The rubber seals 122 are accommodated and held in the accommodation grooves 114c. The rubber seals 122 are each shaped to partially project out of the corresponding accommodation groove 114c (in load-free state) when accommodated and held in the accommodation groove 114c.

The stepping motor 115 is substantially cylindrical and is configured so that a rotary shaft 115b of a rotor 115a projects out of the center of a lower surface of the stepping motor 115. Accordingly, the stepping motor 115 is fixed to the case 114 by screws N (refer to FIG. 18) so that the lower surface of the stepping motor 115 closes the opening of the case 114.

The communication valve 110, which is disk-shaped and has an outer diameter that is slightly smaller than an inner diameter of the case 114, includes a communication hole 110a located at a portion extending in the circumferential direction from where the bottom through holes 114b (first to fourth outlet members 117 to 120) are located in the radial direction. In addition, a shaft portion 110b arranged on the center axis of the communication valve 110 extends toward the stepping motor 115 and is coupled to the rotary shaft 115b to be rotatable integrally with the rotary shaft 115b (not relatively rotatable in the circumferential direction) and movable in an axial direction. The compression coil spring 121 is located between the lower surface of the stepping motor 115 and an upper surface of the communication valve 110 in a state in which the compression coil spring 121 is compressed (with rotary shaft 115b and shaft portion 110b extending through compression coil spring 121). Thus, a lower surface of the communication valve 110 is biased toward the bottom surface of the case 114 squeezing the rubber seals 122 projecting from the accommodation groove 114c. This prevents connection of the first to fourth outlet members 117 to 120 with the inside of the case 114 (i.e., pressure accumulator 111) through a passage other than the communication hole 110a. That is, unintentional leakage of the washer liquid is prevented. As illustrated in FIG. 17, the flow passage switching device 113 of the present embodiment is fixed to the vehicle so that distal ends of the first to fourth outlet members 117 to 120 are directed downward (in direction of gravitational force).

Accordingly, as illustrated in FIG. 16, the inlet member 116 is connected to (in communication with) the check valve 112 by a hose H1, and the check valve 112 is connected to (in communication with) the washer pump 109 by a hose H2. In addition, the first to fourth outlet members 117 to 120 are connected to (in communication with) the first to fourth nozzles 105 to 108 (nozzle openings 105a to 108a) by hoses H. The hose H2 connecting the check valve 112 and the washer pump 109 is a hose having a smaller diameter (inner diameter) than the other hoses H and H1. The other hoses H and H1 (second hose) are hoses having a higher hardness than the hose H2 (first hose) connecting the check valve 112 and the washer pump 109.

As illustrated in FIG. 16, a controller 123 configured to drive and control the washer pump 109 and the stepping motor 115 is electrically connected to the washer pump 109 and the stepping motor 115. For example, when a cleaning switch near the driver seat is operated or a sensor detects a smudge, a control signal for cleaning is received. The controller 123 then controls and drives the washer pump 109 and the stepping motor 115 to eject washer liquid from one of the nozzle openings 105a to 108a. In this case, the controller 123 drives the washer pump 109 in a state in which the communication valve 110 disconnects the flow passage and then stops the washer pump 109. The controller 123 connects the flow passage (pressure accumulator 111) at the side of the washer pump 109 and one of the nozzle openings 105a to 108a with the communication valve 110 in a state in which the washer pump 109 is stopped to eject washer liquid from the nozzle openings 105a to 108a. When the input control signal indicates cleaning, the controller 123 drives the washer pump 109 in a state in which the communication valve 110 disconnects the flow passage. Then, the controller 123 connects the flow passage (pressure accumulator 111) at the side of the washer pump 109 and one of the nozzle openings 105a to 108a with the communication valve 110. The controller 123 continues this process (without any interruption) until the washer liquid is ejected from the nozzle openings 105a to 108a.

A specific actuation example (operation) of the above-described onboard sensor cleaning device will now be described.

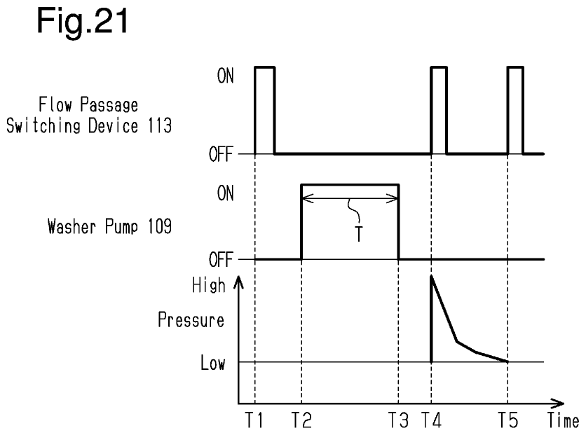

As illustrated in FIG. 21, when a cleaning switch near the driver seat is operated or a sensor detects a smudge at, for example, time T1 before the washer pump 109 is driven, the controller 123 controls and drives the stepping motor 115 so that the communication hole 110a is moved to a predetermined position.

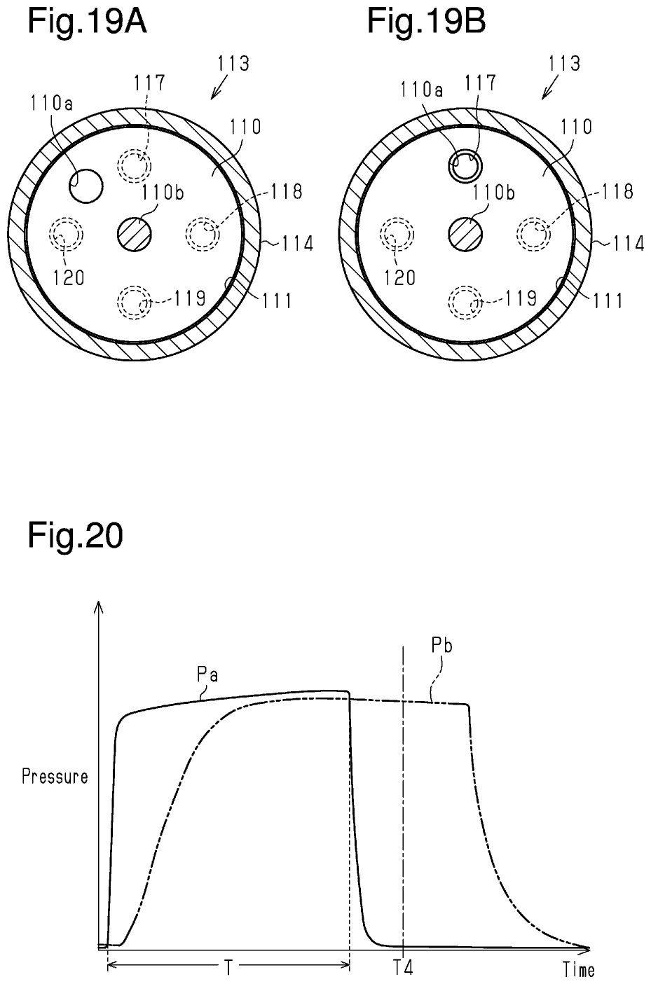

Specifically, as illustrated in FIG. 19A, the controller 123 controls and drives the stepping motor 115 to rotate and drive the communication valve 110 and move the communication hole 110a to a position in the vicinity of the first outlet member 117 between the first outlet member 117 and the fourth outlet member 120. The first outlet member 117 corresponds to the nozzle opening 105a of the first nozzle 105 through which ejection is performed. The stepping motor 115 of the embodiment is configured to be rotatable forward and backward to rotate and drive the communication valve 110 in a direction in which, for example, the amount of rotation from the present position (angle) to the target position would be small.

Subsequently, at time T2, for example, the controller 123 drives the washer pump 109 only for the preset time T in a state in which the flow passage (pressure accumulator 111) at the side of the washer pump 109 is disconnected from the nozzle openings 105a to 108a by the flow passage switching device 113 (communication valve 110).

Consequently, as illustrated in FIG. 20, the pressure Pa at an outlet of the washer pump 109 increases immediately after the washer pump 109 is driven, and the pressure Pa becomes high and remains substantially constant until the preset time T ends (while the washer pump 109 is driven). In this case, as the air in the pressure accumulator 111 is compressed, the pressure Pb in the pressure accumulator 111 (pressure in passage from communication valve 110 to check valve 112) becomes high and substantially the same as the pressure Pa at the outlet of the washer pump 109.

The controller 123 stops the washer pump 109 at time T3 and then connects the flow passage (pressure accumulator 111) at the side of the washer pump 109 and the nozzle opening 105a of the first nozzle 105 through which ejection is performed with the communication valve 110 at time T4.

Specifically, as illustrated in FIG. 19B, the controller 123 controls and drives the stepping motor 115 to rotate and drive the communication valve 110 so that the communication hole 110a coincides with and is connected to the first outlet member 117. In the state of time T4, the pressure Pa at the outlet of the washer pump 109 decreases but the pressure Pb in the pressure accumulator 111 (pressure in passage from the communication valve 110 to check valve 112) is kept high. This ejects high-pressure washer liquid from the nozzle opening 105a of the first nozzle 105, and cleans the lens 101a of the onboard camera 101. When the washer liquid is ejected, the pressure Pb in the pressure accumulator 111 decreases. FIG. 20 illustrates waveforms obtained from experiment results. The pressure Pa is a value obtained by connecting a pressure gauge to the outlet of the washer pump 109, and the pressure Pb is a value obtained by connecting a pressure gauge to the pressure accumulator 111.

Subsequently, the controller 123 controls and drives the stepping motor 115 at time T5 to rotate and drive the communication valve 110 to between the first outlet member 117 and the second outlet member 118. This disconnects the flow passage at the side of the washer pump 109 from the nozzle opening 105a of the first nozzle 105 and stops the ejection of washer liquid from the first nozzle 105 (nozzle opening 105a). In this case, the flow passage switching device 113 (communication valve 110) disconnects the flow passage (pressure accumulator 111) at the side of the washer pump 109 from all of the nozzle openings 105a to 108a. The operation described above can be repeatedly performed to eject washer liquid from the other nozzles 106 to 108 (nozzle openings 106a to 108a).

The advantages of the third embodiment will now be described.

(14) The onboard sensor cleaning device includes the communication valve 110 arranged in the flow passage connecting the nozzle openings 105a to 108a and the washer pump 109. Based on a control signal, the flow passage (pump-side portion of flow passage) at the side of the washer pump 109 is connected with one of the nozzle openings 105a to 108a or the flow passage (pump-side portion of flow passage) at the side of the washer pump 109 is disconnected from all of the nozzle openings 105a to 108a. Thus, the flow passage at the side of the washer pump 109 can be connected with any one of the nozzle openings 105a to 108a when necessary. In addition, the communication valve 110 can disconnect the flow passage at the side of the washer pump 109 from all of the nozzle openings 105a to 108a, and the pressure accumulator 111 is arranged in the flow passage through which the communication valve 110 is connected to the washer pump 109. Thus, when the communication valve 110 disconnects the flow passage and drives the washer pump 109, the pressure of the washer liquid can be increased in the pressure accumulator 111. When the pressure of the washer liquid is high, the flow passage (pressure accumulator 111) at the side of the washer pump 109 and one of the nozzle openings 105a to 108a can be connected with the communication valve 110 to send high-pressure washer liquid to the nozzle openings 105a to 108a and eject the high-pressure washer liquid from one of the nozzle openings 105a to 108a to the corresponding one of the lenses 101a to 104a. This obtains a high cleaning force with a small amount of washer liquid. In addition, in this configuration, there is no need to take into consideration pressure loss in the flow passage connecting the communication valve 110 (or check valve 112) with the washer pump 109 like a configuration that does not include the pressure accumulator 111. Thus, for example, the flow passage can be formed by a thin pipe (hose) or the like. This reduces the cost of parts and simplifies the layout. Specifically, in the present embodiment, the hose H2 that is long, connects the check valve 112 and the washer pump 109, and laid out in the vehicle can be smaller in diameter than the other hoses H and H1. Thus, the hose H2 can be formed by a hose that is inexpensive and easy to lay out. In addition, the hoses H and H1 from the check valve 112 to the nozzle openings 105a to 108a have a higher hardness higher than the hose H2 connecting the check valve 112 and the washer pump 109. Therefore, the flexibility of the hoses H and H1 decreases pressure loss at the corresponding portions. In this configuration, the hose H2 has relatively low hardness and is thus easy to lay out. In addition, the communication valve 110 connects the pressure accumulator 111 to one of the nozzle openings 105a to 108a to eject washer liquid from one of the nozzle openings 105a to 108a at a higher pressure than when the pressure accumulator 111 is simultaneously connected with the plurality of nozzle openings 105a to 108a.

(15) The onboard sensor cleaning device includes the check valve 112 that restricts the flow of washer liquid from the pressure accumulator 111 to the washer pump 109. The check valve 112 is arranged in the flow passage connecting the pressure accumulator 111 and the washer pump 109. This restricts the backflow of washer liquid from the pressure accumulator 11 toward of the washer pump 109 so that the pressure of the washer liquid does not decrease. When the communication valve 110 disconnects the flow passage and drives the washer pump 109, the pressure of the washer liquid in the pressure accumulator 111 increases. After the washer pump 109 is stopped, the communication valve 110 connects the flow passage (pressure accumulator 111) at the side of the washer pump 109 and one of the nozzle openings 105a to 108a to eject only washer liquid at a high pressure. In the present embodiment, the controller 123 performs this operation. That is, for example, in a configuration that does not include the check valve 112, washer liquid needs to be ejected from the nozzle openings 105a to 108a by connecting the flow passage (pressure accumulator 111) at the side of the washer pump 109 and one of the nozzle openings 105a to 108a with the communication valve 110 while driving the washer pump 109 so that the washer liquid in the pressure accumulator 111 does not flow back to the washer pump 109. This may increase power consumption of the washer pump 109, and non-pressurized washer liquid may be ejected. Such a situation does not occur in this case.

(16) The controller 123 drives the washer pump 109 when the flow passage is disconnecting by the communication valve 110 based on the control signal for cleaning and then connects the flow passage (pressure accumulator 111) at the side of the washer pump 109 and one of the nozzle openings 105a to 108a with the communication valve 110. The controller 123 continues (without interrupting) this process until the washer liquid is ejected from the nozzle openings 105a to 108a. Hence, the washer liquid in the pressure accumulator 111 is not left in a high-pressure state. This avoids constant application of high-pressure load to, for example the pressure accumulator 111.

(17) The communication valve 110 is a rotary plate including the communication hole 110a in a portion extending in the circumferential direction. The communication valve 110 is rotated and driven by the stepping motor 115 to connect the communication hole 110a with one of the nozzle openings 105a to 108a and disconnect the communication hole 110a from all of the nozzle openings 105a to 108a. Hence, washer liquid can be ejected at a high pressure from one of the nozzle openings 105a to 108a with a simple configuration including a single drive source (stepping motor 115).

### Fourth Embodiment

A fourth embodiment of the onboard sensor cleaning device will now be described. The description will focus on the difference of the present embodiment from the third embodiment. Same reference numerals are given to those components that are the same as the corresponding components of the third embodiment. Such components will not be described in detail.

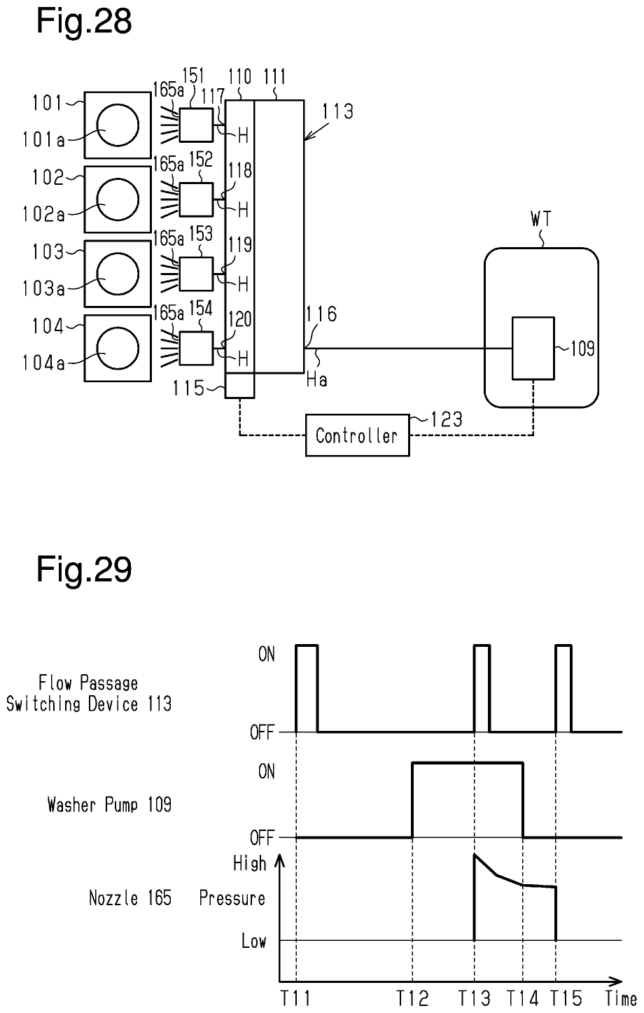

As illustrated in FIG. 28, the onboard sensor cleaning device of the embodiment includes cleaning units 151 to 154 that are integrated with the onboard cameras 101 to 104. In the present embodiment, the flow passage switching device 113 substantially the same as that of the third embodiment. The inlet member 116 arranged in the flow passage switching device 113 is connected to the washer pump 109 by a hose Ha. The check valve 112 of the third embodiment is omitted in the present embodiment. The hose Ha forming the flow passage between the washer pump 109 and the pressure accumulator 111 has a smaller inner diameter than the other hoses H and is thinner. Further, the hose Ha has a lower hardness than the hoses H.

The cleaning units 151 to 154 have substantially the same configuration. Thus, in the description hereafter, only the cleaning unit 151 will be described. The other cleaning units 152 to 154 will not be described.

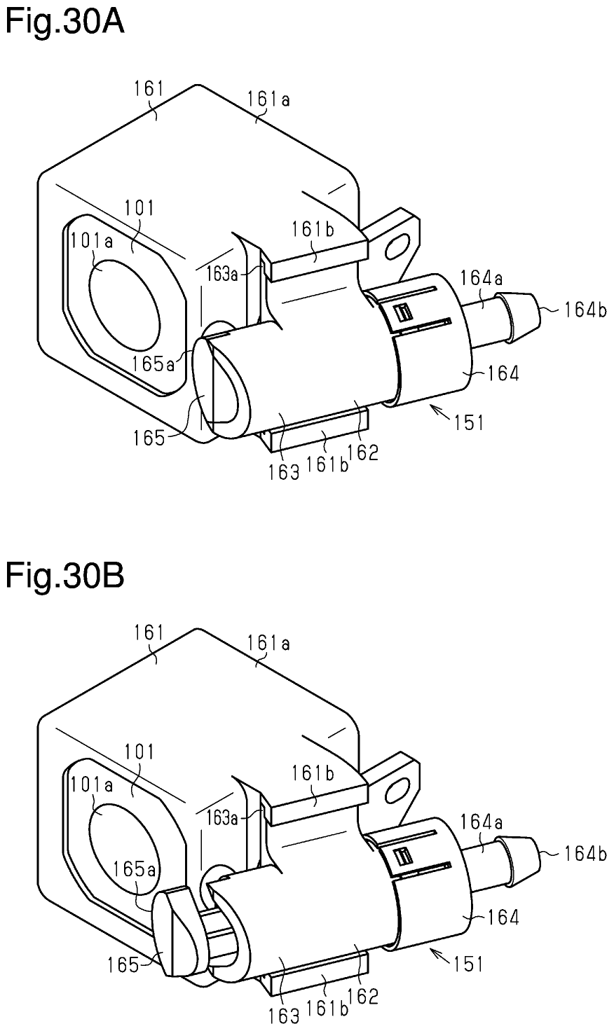

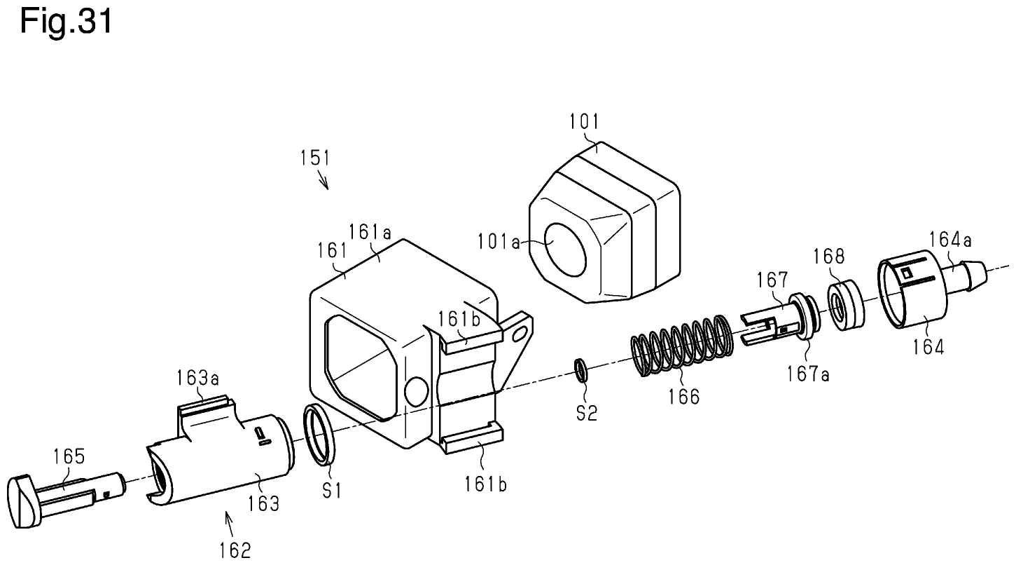

As illustrated in FIGS. 30A, 30B, and 31, the cleaning unit 151 includes a coupling fixing member 161 that is fixed to the onboard camera 101 and a nozzle unit 162 that is fixed to the coupling fixing member 161. The coupling fixing member 161 has a holder 161a that is substantially box-shape and allows the onboard camera 101 to be fitted therein. The onboard camera 101 is fitted into the holder 161a to fix the coupling fixing member 161 to the onboard camera 101. FIG. 28 illustrates a state in which the onboard camera 101 is separated from the cleaning unit 151.

In addition, the coupling fixing member 161 includes two holding pieces 161b. The two holding pieces 161b include opposing surfaces with a groove formed in each surface. The nozzle unit 162 is coupled in a removable manner to the holding pieces 161b.

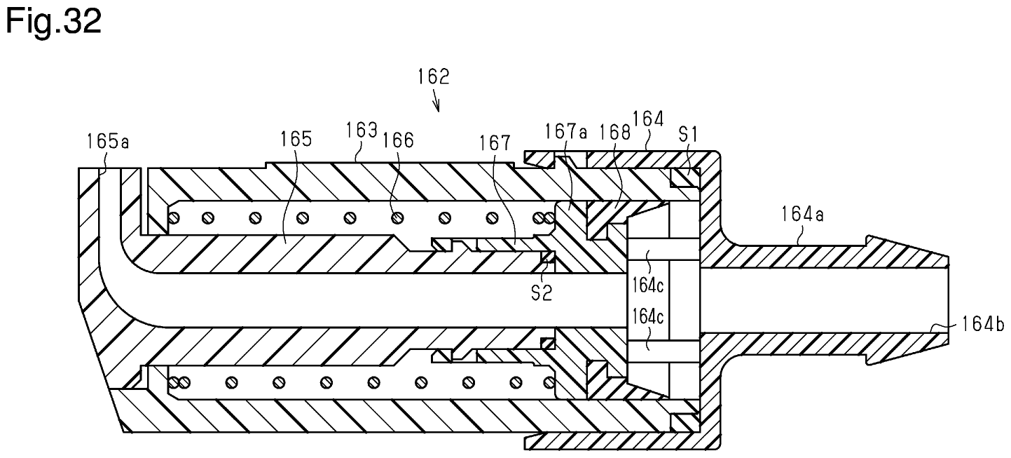

The nozzle unit 162 includes a first case 163 that is substantially cylindrical shape and a second case 164 that is fitted onto and fixed to a proximal side of the first case 163. Two fixing projections 163a (only one shown in FIGS. 30A, 30B, and 31) are formed on the outer circumference of the first case 163 and fitted into the grooves of the holding pieces 161b so that the nozzle unit 162 is coupled in a removable manner to the holding pieces 161b (coupling fixing member 161). A cylindrical inlet tube 164a projects from a bottom portion of the second case 164. The inner side of the inlet tube 164a defines an inlet port 164b (refer to FIG. 32) connected to the inside of the first case 163. A seal ring S1 is located between the first case 163 and the second case 164. The first outlet member 117 is connected to the inlet port 164b by the hose H. The second to fourth outlet members 118 to 120 are connected to the inlet ports 164b of the other cleaning units 152 to 154 by the hoses H.

In addition, as illustrated in FIGS. 31 and 32, the nozzle unit 162 includes a movable nozzle 165 and a compression coil spring 166. The movable nozzle 165 is movable forward and backward to be projected out of and retracted into an opening in the distal end of the first case 163. The compression coil spring 166 serves as a biasing member that biases the movable nozzle 165 in a backward direction (proximal end direction of first case 33).

More specifically, as illustrated in FIG. 32, the movable nozzle 165 is cylindrical and has a smaller diameter than the first case 163. The movable nozzle 165 has a distal end directed sideward (direction orthogonal to longitudinal direction) to form a nozzle opening 165a. A proximal end member 167 is fitted onto a proximal portion of the movable nozzle 165. A seal ring S2 is located between the movable nozzle 165 and the proximal end member 167. The proximal end member 167 has a flange 167a that extends radially outward, and the flange 167a is biased by a compression coil spring 166. One end of the compression coil spring 166 is supported by the distal end of the first case 163. This biases the movable nozzle 165 is biased in the retracting direction (right direction as viewed in FIG. 32). In addition, an annular seal member 168 that slides in contact with an inner circumferential surface of the first case 163 is fitted to a proximal portion of the proximal end member 167.

Further, the bottom portion of the second case 164 includes a restriction post 164c that extends toward a side opposite to the inlet tube 164a. In this example, three restriction posts 164c (only two shown in FIG. 32) are formed at equal angular intervals in the circumferential direction. The restriction post 164c contact a proximal end surface of the proximal end member 167 biased by the compression coil spring 166 to restrict further retraction of the proximal end member 167 (movable nozzle 165) beyond the position of contact.

When washer liquid is supplied from the inlet port 164b to the inside of the movable nozzle 165, the proximal end surface of the proximal end member 167 is biased by the pressure of the washer liquid. This moves the movable nozzle 165 forward against the biasing force of the compression coil spring 166.

In the onboard sensor cleaning device, the movable nozzle 165 is moved forward and backward so that the nozzle opening 165a of the movable nozzle 165 is movable to a cleaning position, which is close to an image capturing range (center of image capturing range) of the onboard camera 101 and a non-cleaning position, which is farther from the image capturing range than the cleaning position. The image capturing range of the present embodiment is a range in which the onboard camera 101 (imaging element thereof) captures images through the lens 101a.

More specifically, in the present embodiment, the non-cleaning position is set at a position where the nozzle opening 165a is located outside the image capturing range of the onboard camera 101, and the cleaning position is set at a position where the nozzle opening 165a is located inside the image capturing range of the onboard camera 101. Thus, in a backward state in which the movable nozzle 165 is moved backward (state in which proximal end surface of proximal end member 167 is in contact with restriction posts 164c), the nozzle opening 165a is located outside the image capturing range of the onboard camera 101 at the non-cleaning position. In a forward state in which the movable nozzle 165 is moved forward, the nozzle opening 165a is located inside the image capturing range of the onboard camera 101 at the cleaning position.

In the present embodiment, the direction in which the movable nozzle 165 is movable forward and backward is inclined relative to a direction extending toward the lens 101a of the onboard camera 101 (central axis line of lens 101a, or image capturing axis). That is, when the movable nozzle 165 is moved forward in the forward state, the nozzle opening 165a is close to the image capturing axis (central axis line of lens 101a) and arranged at a position close to the center of the image capturing range of the onboard camera 101, and the nozzle opening 165a is inclined so that the washer liquid is ejected from the nozzle opening 165a to a central position of the lens 101a.

In the present embodiment, the movable nozzle 165 is located sideward in the horizontal direction from the onboard camera 101 so that the nozzle opening 165a is located sideward in the horizontal direction from the lens 101a at the non-cleaning position.

An actuation example (operation) of the onboard optical sensor cleaning device of the present embodiment will now be described.

First, in a state in which the washer pump 109 is not driven, the movable nozzle 165 is in a state moved backward to the non-cleaning position by the biasing force of the compression coil spring 166 (refer to FIG. 30A). Thus, the nozzle opening 165a (distal portion of movable nozzle 165) is located outside the image capturing range of the onboard camera 101. Hence, when the cleaning is not performed and an image is captured, the nozzle opening 165a (distal portion of movable nozzle 165) does not interfere with image capturing.

As illustrated in FIG. 29, when, for example, a cleaning switch near the driver seat is operated or a sensor detects a smudge at time T11, which is before the washer pump 109 is driven, the controller 123 controls and drives the stepping motor 115 to move the communication hole 110a to a predetermined position.

Specifically, as illustrated in FIG. 19A, the controller 123 controls and drives the stepping motor 115 to rotate and drive the communication valve 110 to move the communication hole 110a to a position corresponding to the nozzle opening 165a of the movable nozzle 165 of the cleaning unit 151 located in the vicinity of the first outlet member 117 between the first outlet member 117 and the fourth outlet member 120. The stepping motor 115 of the embodiment is configured to be rotatable forward and backward to rotate and drive the communication valve 110 in a direction in which, for example, the amount of rotation from the present position (angle) to the target position would be small.

Subsequently, at time T12, for example, the controller 123 drives the washer pump 109 only for the preset time T in a state in which the flow passage (pressure accumulator 111) at the side of the washer pump 109 is disconnected from all of the nozzle openings 165a of the cleaning units 151 to 154 by the flow passage switching device 113 (communication valve 110). Consequently, the pressure at the outlet of the washer pump 109 increases immediately after the washer pump 109 is driven, and the pressure becomes high and remains substantially constant. In this case, the pressure in the pressure accumulator 111 also becomes high.

Then, at time T13, for example, the controller 123 drives the stepping motor 115 to connect the flow passage (pressure accumulator 111) at the side of the washer pump 109 and the nozzle opening 165a of the movable nozzle 165 of the cleaning unit 151 through which ejection is performed with the flow passage switching device 113 (communication valve 110).

Specifically, as illustrated in FIG. 19B, the controller 123 controls and drives the stepping motor 115 to rotate and drive the communication valve 110 so that the position of the communication hole 110a coincides with and is connected to the first outlet member 117. This ejects high-pressure washer liquid from the nozzle opening 165a of the movable nozzle 165 of the cleaning unit 151, and cleans the lens 101a of the onboard camera 101. When the washer liquid is ejected, the pressure Pb in the pressure accumulator 111 decreases.

Subsequently, the controller 123 stops the washer pump 109 at time T14.

Then, the controller 123 controls and drives the stepping motor 115 at time T15 to rotate and drive the communication valve 110 to between the first outlet member 117 and the second outlet member 118. This disconnects the flow passage at the side of the washer pump 109 from the nozzle opening 165a of the movable nozzle 165 of the cleaning unit 151 and stops the ejection of washer liquid from the movable nozzle 165 (nozzle opening 165a).

In addition to advantages (14), (16), and (17) of the third embodiment, the onboard sensor cleaning device has the advantages described below.

(18) The movable nozzle 165, which includes the nozzle opening 165a, is movable to move the nozzle opening 165a to the cleaning position that is close to the center inside the image capturing range of the onboard camera 101 and the non-cleaning position that is farther from the center of the image capturing range than the cleaning position. Thus, the nozzle opening 165a is movable to the cleaning position during cleaning, and the movable nozzle 165 can smoothly clean the lenses 101a to 104a without interfering with image capturing.

(19) The movable nozzle 165, which includes the nozzle opening 165a, is movable forward and backward to the cleaning position and the non-cleaning position. This reduces the region required for movement as compared with, for example, when relatively moving an external imaging surface (lens 101a to 104a) and the nozzle opening 165a.

(20) The onboard cameras 101 to 104 including the lenses 101a to 104a are fixed to the vehicle and thus, for example, capture stable images. Further, the nozzle opening 165a is arranged in the movable nozzle 165 that is supported by the vehicle in a manner movable forward and backward. Thus, forward and backward movement is performed more easily than when fixing the nozzle opening 165a and moving the onboard cameras 101 to 104 forward and backward instead. That is, when, for example, the external imaging surfaces (lenses 101a to 104a) are movable forward and backward, a mechanism including the onboard cameras 101 to 104 will be enlarged. Compared to such a mechanism, the movable nozzle 165 is smaller and lighter in a configuration in which the external imaging surface is provided directly or indirectly on the vehicle (onboard cameras 101 to 104). Therefore, the configuration that moves the movable nozzle 165 forward and backward allows for easy switching between forward and backward movement.

(21) The nozzle opening 165a of the movable nozzle 165 is movable forward to approach the lenses 101a to 104a of the onboard cameras 101 to 104. This allows the movable nozzle 165 to easily eject the washer liquid from, for example, a forward position located close to the image capturing axis (central axis of lenses 101a to 104a) to the center positions of the lenses 101a to 104a. Thus, the lenses 101a to 104a can be cleaned in a further satisfactory manner.

(22) The movable nozzle 165 is moved forward to the cleaning position by the pressure of the washer liquid (fluid). Thus, there is no need to provide an electric drive unit or the like that moves the movable nozzle 165 forward. This allows the configuration to be simplified.

(23) Since the movable nozzle 165 is moved backward to the non-cleaning position by the biasing force of the compression coil spring 166 (biasing member). Thus, there is no need for an electric drive unit or the like that moves the movable nozzle 165 backward. This allows the configuration to be simplified.

(24) The nozzle unit 162, which includes the movable nozzle 165 that is movable forward and backward, is coupled in a removable manner to the vehicle. Thus, the nozzle unit 162 is easy to remove and replace with a new nozzle unit when, for example, the movable nozzle 165 fails to move forward or backward.

(25) The nozzle opening 165a is rectangular when viewed from an opening direction. This allows washer liquid to be ejected over a wide region while maintaining high ejection pressure. Thus, the lenses 101a to 104a can be cleaned in a further satisfactory manner.

(26) The fluid is a mixture of the washer liquid (liquid) and air. Thus, the lenses 101a to 104a can be cleaned in a further satisfactory manner by increasing the ejection pressure (increasing flow speed) compared to when the fluid includes only the washer liquid (liquid), for example. Further, the consumption amount of the washer liquid can be reduced.

(27) The nozzle opening 165a is only arranged sideward in the horizontal direction from the lenses 101a to 104a at the non-cleaning position. Thus, even when, for example, liquid falls from the nozzle opening 165a at the non-cleaning position after cleaning, the liquid will not collect on the lenses 101a to 104a.

(28) The non-cleaning position is where the nozzle opening 165a is located outside the image capturing range of the onboard cameras 101 to 104, and the cleaning position is where the nozzle opening 165a is located inside the image capturing range of the onboard cameras 101 to 104. The nozzle opening 165a is movable to the cleaning position only during cleaning. Thus, the lenses 101a to 104a can be cleaned in a further satisfactory manner without interfering with the capturing of images.

The embodiments may be modified as described below.

The above-described embodiments employ a seal structure in which the rubber seal 122 is accommodated and held in the accommodation groove 114c of the case 114. However, any structure may be employed as long as the first to fourth outlet members 117 to 120 can be disconnected from the inside of the case 114 (i.e., pressure accumulator 111) except through the communication hole 110a to prevent unintentional leakage of the washer liquid.

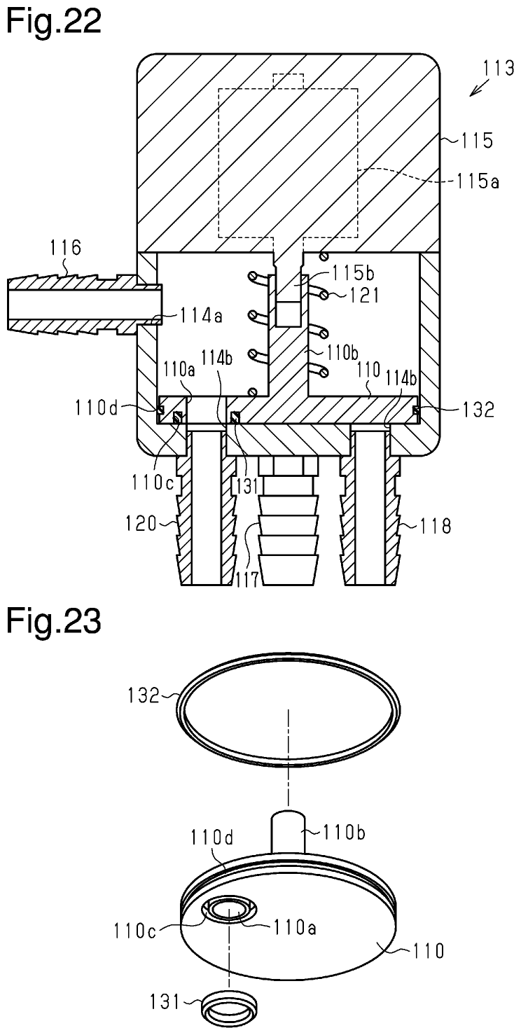

FIGS. 22 and 23 show an example of a modification. In this example, a lower surface accommodation groove 110c is formed around the communication hole 110a in the lower surface of the communication valve 110, and an annular rubber seal 131 is accommodated and held in the lower surface accommodation groove 110c. In addition, an outer circumference accommodation groove 110d is formed in the entire outer circumferential surface of the communication valve 110, and an annular rubber seal 132 is accommodated and held in the outer circumference accommodation groove 110d. In this configuration, the rubber seals 131 and 132, which partially project out of the lower surface accommodation groove 110c and the outer circumference accommodation groove 110d, are pressed by opposing surfaces of the case 114. This also prevents unintentional leakage of the washer liquid.

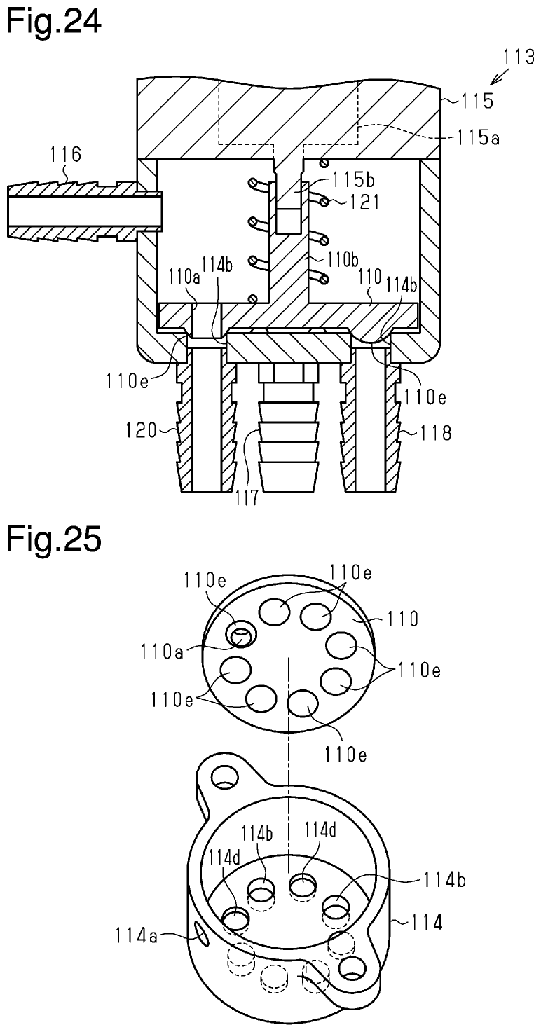

FIGS. 24 and 25 show an example of a modification. In this example, the bottom portion of the case 114 includes recessed portions 114d (refer to FIG. 25) having the same diameter as the bottom through holes 114b and located between the bottom through holes 114b in the circumferential direction. In addition, the lower surface of the communication valve 110 includes eight spherical projecting portions 110e that are spherical and arranged at equal angular intervals (45°). The communication hole 110a extends through one of the spherical projecting portions 110e. In this manner, the spherical projecting portions 110e (spherical surface) contact the bottom through holes 114b and an open part of the recessed portion 114d to prevent unintentional leakage of the washer liquid. This allows the rubber seals to be omitted.

In addition, for example, the accommodation grooves 114c and the rubber seals 122 may be omitted from of the above embodiment. Further, the flatness of opposing surfaces may be increased so that the opposing surfaces contact and press each other to prevent unintentional leakage of the washer liquid. In addition, in a configuration that does not use the rubber seal (configuration in which flatness is increased or configuration of FIGS. 24 and 25), for example, at least one of the communication valve 110 and the case 114 may be a two-color molded product including a soft resin (portion that contacts and presses another member is molded from a soft resin) to prevent unintentional leakage of the washer liquid.

In the third and fourth embodiments, the case 114 includes the pressure accumulator 111. This configuration may be changed to another configuration.

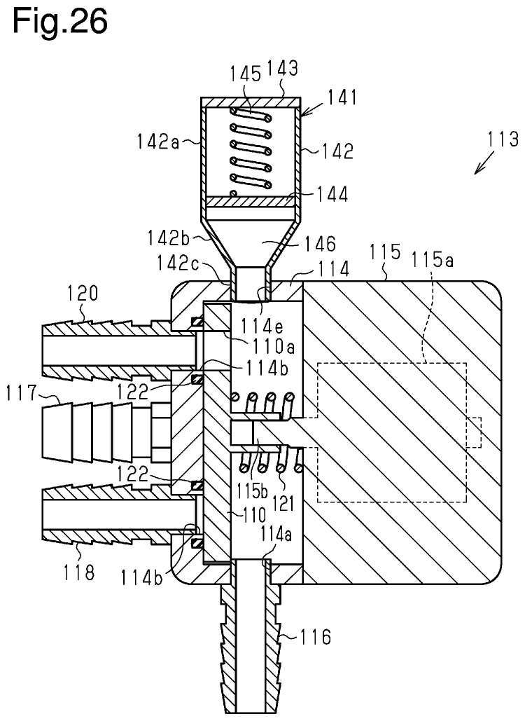

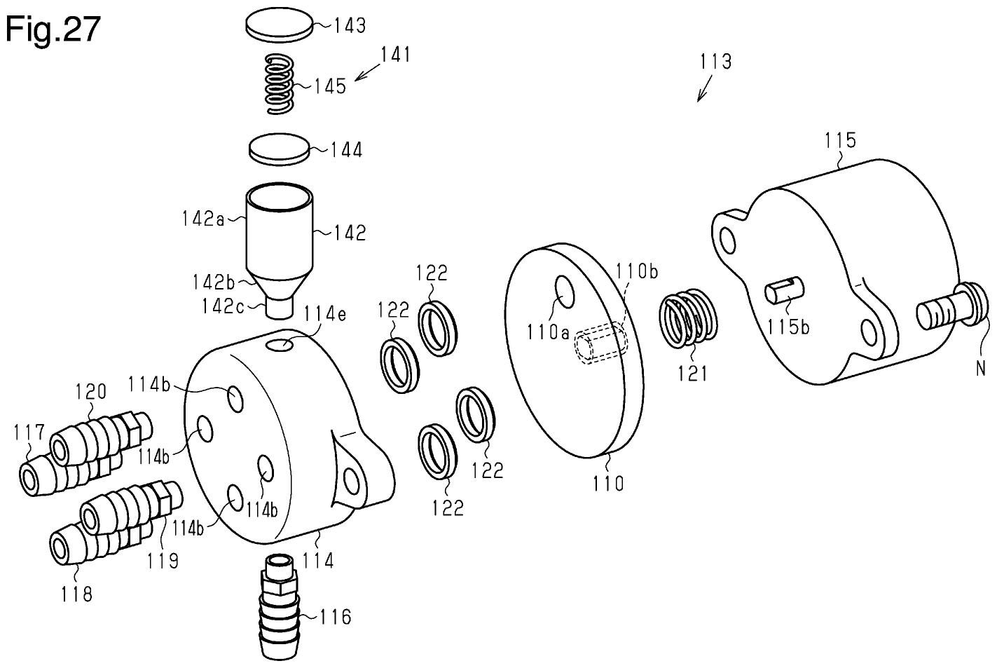

FIGS. 26 and 27 show an example of a modification. In this example, the case 114 is shorter in length (volume) in the axial direction than the other embodiments. Accordingly, a pressure-accumulating-chamber fixing hole 114e is formed in the circumferential wall of the case 114 at the opposite side of the circumferential wall through hole 114a separated by an angle of 180°. A pressure-accumulating-chamber member 141 is fixed to the pressure-accumulating-chamber fixing hole 114e projecting outward. The pressure-accumulating-chamber member 141 includes a housing 142, a lid 143, a movable member 144, and a coil spring 145. The housing 142 includes a cylindrical portion 142a that is cylindrical, a diameter decreasing portion 142b having a diameter that gradually decreases downward from a lower end of the cylindrical portion 142a, and a small-diameter portion 142c that is cylindrical and extends from a lower end of the diameter decreasing portion 142b. A distal end of the small-diameter portion 142c is fixed to the pressure-accumulating-chamber fixing hole 114e. The lid 143 is disk-shaped and closes the upper end of the cylindrical portion 142a. The movable member 144 is disk-shape and slides along an inner circumferential surface of the cylindrical portion 142a so as to be movable along the axial direction of the cylindrical portion 142a. A rubber seal (not illustrated) or the like is arranged on, for example, an outer circumferential surface of the movable member 144 to hermetically seal the space at the side of the case 114. Accordingly, the coil spring 145 is located between the lid 143 and the movable member 144. In this example, the case 114 and the pressure-accumulating-chamber member 141 form a pressure accumulator 146. The flow passage switching device 113 that is formed in this manner is fixed to the vehicle so that the pressure-accumulating-chamber member 141 is directed upward (antigravity direction).

In this manner, when the washer pump 109 is driven in a state in which the flow passage (pressure accumulator 146) at the side of the washer pump 109 is disconnected from all of the nozzle openings 105a to 108a, the movable member 144 is pushed upward against a biasing force of the coil spring 145 as washer liquid accumulates in the case 114 and air is compressed in the pressure accumulator 146. This increases the pressure of the pressure accumulator 146. For example, when the communication valve 110 connects the pressure accumulator 146 and the nozzle opening 105a of the first nozzle 105 performing ejection, washer liquid is ejected at a high pressure from the nozzle opening 105a to clean the lens 101a of the onboard camera 101 as the biasing force of the coil spring 145 moves the movable member 144 downward.

The pressure accumulator 111 and the communication valve 110 are integrated to configure the flow passage switching device 113. However, there is no limit to such a configuration.

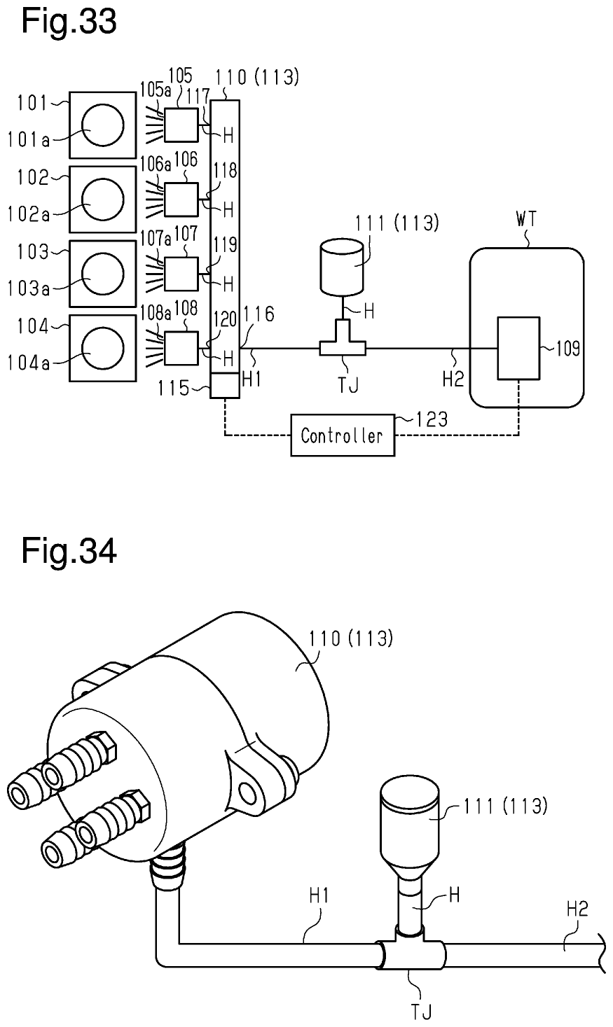

As illustrated in FIGS. 33 and 34, the pressure accumulator 111 and the communication valve 110 may be separate. In the configuration illustrated in FIGS. 33 and 34, the pressure accumulator 111 is connected to the T-shaped joint TJ by a hose H, and the T-shaped joint TJ is connected to the communication valve 110 and the washer pump 109 by a hose H1 and a hose H2. FIG. 33 illustrates a configuration in which the check valve 112 is omitted. However, the check valve 112 may be arranged between the T-shaped joint TJ and the washer pump 109.

The above embodiments are applied to onboard sensor cleaning devices that eject washer liquid. However, there is no limit to such a configuration, and the onboard sensor cleaning device may eject air.

For example, the washer pump 109 may be changed to an air pump configured to deliver air.

In the third embodiment, the hardness of the hoses H and H1 used from the check valve 112 to the nozzle openings 105a to 108a has a higher hardness than the hose H2 used from the check valve 112 to the washer pump 109. However, there is no limit to such a configuration, and the hoses may all have the same hardness.

In the third embodiment, the controller 123 continuously (without interrupting) performs the process until the washer liquid is ejected based on a control signal for cleaning; however. Instead, the controller 123 may interrupt the process.

In the third and fourth embodiments, the communication valve 110 is a rotary plate including the communication hole 110a in a portion extending in the circumferential direction and rotated and driven by the stepping motor 115. However, the communication valve 110 may employ another configuration as long as the communication valve 110 can connect the pressure accumulator 111 and one of the nozzle openings 105a to 108a and 165a and disconnect the pressure accumulator 111 and all of the nozzle openings 105a to 108a.

The number of nozzle openings 105a to 108a and 165a and the number of the corresponding first to fourth outlet members 117 to 120 or the like of the third and fourth embodiment may be changed to any plural number.

Although not described in the third and fourth embodiments, for example, when a cleaning subject does not need to be cleaned by ejecting high-pressure fluid or the like, the washer pump 109 may be driven without the communication valve 110 disconnecting the flow passage, and the washer liquid may be sent to one of the nozzle openings 105a to 108a or 165a. That is, the flow passage switching device 113 may be used as a switching unit that simply switches the flow passages.

In the third embodiment, the controller 123 drives the washer pump 109 only for the preset time T (refer to FIG. 20). Instead, for example, after the washer pump 109 is driven, the controller 123 may stop the washer pump 109 based on the pressure in the pressure accumulator 111. In addition, the controller 123 may rotate and drive the communication valve 110 based on time or pressure instead of time T.

The third embodiment is configured and controlled so that when the washer liquid is ejected once, the pressure Pb in the pressure accumulator 111 decreases to substantially zero (washer pump 109 needs to be driven again to perform ejection for second time). Instead, a configuration and control may be employed so that when the pressure of the washer liquid in the pressure accumulator 6 is increased once, the washer liquid is ejected a multiple number of times.

In the third and fourth embodiments, the liquid is ejected to clean the lenses 101a to 104a of the onboard cameras 101 to 104. However, the fluid may be ejected to clean a sensing surface (lens, cover glass, or the like) of an onboard sensor other than the onboard cameras 101 to 104. For example, the onboard sensor may be an optical sensor (i.e., Lidar) that emits (radiates) infrared laser and receives scattered light reflected from an object to measure the distance to the object. In addition, radar (e.g., millimeter wave radar) that uses radio waves or an ultrasonic sensor used as a corner sensor may be employed. In addition, in a case where the sensing surface that is the cleaning subject is a cover glass or the like having a relatively large area, the washer liquid may be, for example, sequentially ejected from a plurality of nozzle openings to one sensing surface.

In the third and fourth embodiments, the communication valve 110 connects the pressure accumulator 111 and one of the nozzle openings 105a to 108a and 165a. However, the communication valve 110 may simultaneously connect the pressure accumulator 111 and the plurality of nozzle openings 105a to 108a and 165a.

The first to fourth embodiments and the modified examples may be combined.

This disclosure is described in accordance with an example; however, this disclosure is understood not to be limited to the example or the structure. This disclosure also includes various modified examples or modifications within the scope of equivalence. Additionally, various combinations or aspects and another combination or aspect obtained by adding only one element, one or more elements, or one or less elements to the various combinations or aspects are all included in the spirit of scope of this disclosure.

1. An onboard sensor cleaning device comprising:
a nozzle opening that ejects fluid to a sensing surface of an onboard sensor;
a pump that sends fluid to the nozzle opening;
a flow passage that connects the nozzle opening and the pump;
an on-off valve arranged in the flow passage to open and close the flow passage based on a control signal; and
a pressure accumulator arranged in the flow passage in a pump-side portion that is a portion between the on-off valve and the pump.

2. The onboard sensor cleaning device according to claim 1, further comprising:
a check valve that is provided in the flow passage in a portion between the pressure accumulator and the pump to restrict flow of fluid from the pressure accumulator to the pump.

3. The onboard sensor cleaning device according to claim 2, wherein the nozzle opening, the on-off valve, the pressure accumulator, and the check valve are arranged in a single housing.

4. The onboard sensor cleaning device according to claim 2, further comprising:
a controller that controls the on-off valve and the pump,
wherein the controller is configured to drive the pump in a state in which the on-off valve closes the flow passage and then open the flow passage with the on-off valve to eject fluid from the nozzle opening in a state in which the pump is stopped.

5. The onboard sensor cleaning device according to claim 1, wherein
a portion of the flow passage between the pressure accumulator and the pump is configured by a first hose,
a portion of the flow passage between the pressure accumulator and the nozzle opening is configured by a second hose, and
at least part of the first hose has a smaller inner diameter than the second hose.

6. The onboard sensor cleaning device according to claim 1, wherein
a portion of the flow passage between the pressure accumulator and the pump is configured by a first hose,
a portion of the flow passage between the pressure accumulator and the nozzle opening is configured by a second hose, and
at least part of the first hose has a lower hardness than the second hose.

7. The onboard sensor cleaning device according to claim 1, wherein
the pressure accumulator is configured to store air that is compressed by a washer liquid sent from the pump, and
the onboard sensor cleaning device further comprising:
a sub-nozzle opening that ejects air to the sensing surface;
a further flow passage that connects the sub-nozzle opening and the pressure accumulator; and
a sub-on-off valve that is arranged in the further flow passage to open and close the further flow passage based on a sub-control signal.

8. The onboard sensor cleaning device according to claim 1, wherein
the nozzle opening is one of a plurality of nozzle openings, and
the on-off valve is a communication valve that can connect the pump-side portion of the flow passage to at least one of the plurality of nozzle openings and disconnect the pump-side portion of the flow passage from all of the plurality of nozzle openings.

9. The onboard sensor cleaning device according to claim 8, further comprising:
a check valve arranged in the flow portion in a portion between the pressure accumulator and the pump to restrict flow of fluid from the pressure accumulator to the pump.

10. The onboard sensor cleaning device according to claim 9, further comprising:
a controller that controls the communication valve and the pump,
wherein the controller is configured to drive the pump in a state in which the communication valve disconnects the flow passage and then connect the pump-side portion of the flow passage and one of the plurality of nozzle openings to eject fluid from the nozzle opening in a state in which the pump is stopped.

11. The onboard sensor cleaning device according to claim 9, wherein
a portion of the flow passage between the check valve and the nozzle opening is configured by a second hose,
a portion of the flow passage between the check valve and the pump is configured by a first hose, and
the second hose has a hardness set to be higher than that of the first hose.

12. The onboard sensor cleaning device according to claim 8, further comprising:
a controller that controls the communication valve and the pump,
wherein the controller is configured to drive the pump based on a control signal for cleaning in a state in which the flow passage is disconnected by the communication valve and then continuously perform a process until fluid is ejected from the nozzle opening in a state in which the pump-side portion of the flow passage is connected to one of the plurality of nozzle openings by the communication valve.

13. The onboard sensor cleaning device according to claim 8, further comprising:
a drive source, wherein
the communication valve is a rotary plate including a communication hole arranged in a portion of the rotary plate extending in a circumferential direction, and
the communication valve can be rotated and driven by the drive source to connect the communication hole to one of the plurality of nozzle openings and disconnect the communication hole from all of the plurality of nozzle openings.

14. The onboard sensor cleaning device according to claim 8, wherein the communication valve is configured to allow the pressure accumulator and one of the plurality of nozzle openings to be connected.
